(19) United States
(12) Patent Application Publication
(10) Pub. No.: US 2026/0340113 A1
(43) Pub. Date: Oct. 29, 2026

(54) SYSTEM FOR RESTORING POWER IN ELECTRICAL GRID AFTER CYBER-PHYSICAL ATTACK

(71) Applicant: UNIVERSITY OF CENTRAL FLORIDA RESEARCH FOUNDATION, INC., Orlando, FL (US)

(72) Inventors: Wei SUN, Oviedo, FL (US); Xue GAO, Oviedo, FL (US); Mazhar ALI, Orlando, FL (US)

(21) Appl. No.: 19/089,443

(22) Filed: Mar. 25, 2025

Related U.S. Application Data
(60) Provisional application No. 63/659,865, filed on Jun. 14, 2024.

(51) Int. Cl. G06F 21/55; G05B 19/042

(52) U.S. Cl. CPC G06F 21/554; G05B 19/042; G05B 2219/2639; G06F 2221/034

(57) ABSTRACT

A system for restoring an electrical distribution grid from cyber-physical attacks includes local controllers with grid-edge, inverter-based resource (IBR) field devices that collect IBR field device measurement data and compute power ratio deviations and regulate terminal voltages and system frequency of a respective IBR field device. IBR manager clients communicate with IBR local controller clusters and neighboring IBR manager clients and receive IBR field device measurement data and power ratio deviations and direct a selected local controller to adjust terminal voltage and system frequency within a connected IBR field device. A management server system implements a distributionally robust optimization (DRO) model and generates a sub-grid plan of terminal voltages and system frequencies for IBR manager clients and local controllers that minimizes expected load loss and compensates for power ratio deviations when subject to a cyber-physical attack.

### PRIORITY APPLICATION(S)

This application is based upon U.S. provisional patent Application No. 63/659,865 filed Jun. 14, 2024, the disclosure which is hereby incorporated by reference in its entirety.

### GOVERNMENT LICENSE RIGHTS

This invention was made with government support under the U.S. Department of Energy, UCF Project Number AWD00001216, and Sponsor Grant or Award Number DE-EE0009339. The government has certain rights in this invention.

### FIELD OF THE INVENTION

The present invention relates to the field of electrical distribution, and more particularly, this invention relates to a system for restoring power in an electrical power system from a cyber-physical or similar attack.

### BACKGROUND OF THE INVENTION

The reliable operation of active distribution grids with the increasing penetration of distributed energy resources (DERs), especially the inverter-based resources (IBRs) at the grid edge, often depends on DER communication with the industrial Internet of things (IIoT). Utilities can deploy a cyber-physical system (CPS) architecture to achieve real-time monitoring, control, and optimization of grid operations. While this new paradigm of operation relies on multiple hardware components, software products, and embedded systems, the interconnection of these components across different layers and elements has also introduced potential vulnerabilities, providing opportunities for adversaries to exploit and execute sophisticated cyber-physical attacks. Notably, there have been instances of cyber-attacks targeting critical infrastructures, including the 2021 Colonial Pipeline and Saudi Aramco ransomware attacks, the 2020 U.S. Department of Health & Human Services breach, and the 2015 and 2016 Ukrainian power grid attacks.

Once these cyberattacks cause damages to critical infrastructures, it is a new challenge for resilient cyber-physical restoration. In many electrical power systems, traditional restoration approaches consider components in the physical system, with the criteria of restoration time, recovered energy, the number of served customers, the recovery of prioritized loads, etc., to evaluate the performance of restoration process. Recently, several works have been proposed with different cyber-physical restoration goals.

There have been collaborative efforts of cyber and physical subsystem restorations in a distribution grid, highlighting the significance of microgrids in accelerating the restoration process under extreme weather events. They measure the effectiveness of restoration activities in terms of restoration rapidity using a resilience index. Some enhance the cyber-physical power system recovery through a coordinated strategy, factoring in information system impact on grid maintenance and avoid the island operation of information systems, while restoring the key communication among generators, loads, and fault lines. This accelerates load recovery, reducing power outage losses compared to the independent schemes.

Some systems present a distributed adaptive restoration scheme to enhance the resilience of cyber-physical active distribution systems, through a two-stage robust restoration scheme using distributed optimization techniques or a cyber-physical interdependent restoration scheduling framework for active distribution grids. The system may coordinate repair crews, operating crews, and system operations with DERs, and address the uncertainty of renewable energy resources via a two-stage robust optimization model.

Another system has focused on a cyber restoration concept to recover power system observability after widespread attacks. That system establishes analogies between physical and cyber system restoration and presents a generic cyber restoration planning idea via a restoration strategy of a phasor measurement unit network.

There are gaps in cyber-physical restoration, however, that overlook critical aspects such as detection and localization of attacks, subsequent isolation, pre-recovery steps based on cyber-physical interdependencies, situational awareness, and final recovery and assessment measures. Therefore, there is a requirement for an improved resilient CPS restoration framework for the efficient detection, isolation, and recovery from cyber-physical attacks, taking into consideration the interdependency between cyber and physical layers were considered.

### SUMMARY OF THE INVENTION

A system for restoring an electrical distribution grid from cyber-physical attacks may comprise a plurality of local controllers, each having a grid-edge, inverter-based resource (IBR) field device connected thereto and arranged in a plurality of IBR local controller clusters and configured to collect IBR field device measurement data from the respective IBR field device connected thereto and compute power ratio deviations and regulate terminal voltages and system frequency of respective IBR field devices. A plurality of IBR manager clients each communicate with one or more IBR local controller clusters and one or more neighboring IBR manager clients and receive IBR field device measurement data and power ratio deviations for each IBR field device in communication therewith and direct a respective local controller to adjust terminal voltage and system frequency within a connected IBR field device. A management server system may be connected to the plurality of IBR manager clients and implements a distributionally robust optimization (DRO) model and generates a sub-grid plan of terminal voltages and system frequencies for the IBR manager clients and local controllers that minimizes expected load loss based upon a cyber-physical attack.

The DRO model may integrate an ambiguity set to address a cyber-physical attack scenario uncertainty. The ambiguity set may comprise a Wasserstein ball-based distribution set that presents a possibility level of each attack scenario. The management server system may be configured to generate the sub-grid plan using spatial-temporal correlations among voltage phasors at nodal buses defined by IBR field devices. The management server system may be configured to compute unknown voltages from spatial-temporal correlations. The sub-grid plan includes isolation of IBR field devices and local controllers within the electrical distribution grid. Each of the IBR field devices may comprise an electric field sensor.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a block diagram of the system for restoring power in accordance with an embodiment.

FIG. 2 in a block diagram showing stages in the restoration framework for the system.

FIG. 3 is a chart showing the consequences of denial-of-service and man-in-the-middle attacks.

FIG. 4 is a chart showing the consequences of false-data-ejection and device manipulation attacks.

FIG. 5 is a chart showing the consequences of coordinated multi-stage and multi-wave attacks.

FIG. 6 is a flow sequence diagram showing attack verification, post-attack detection, and localization under cyber-physical attacks.

FIG. 7 is a flow sequence diagram showing isolation and pre-recovery under cyber-physical attacks.

FIG. 8 is a schematic topology drawing showing a 13-node distribution grid as a cyber-physical system.

FIG. 9 is a schematic topology drawing showing post-attack detection and localization in both IT and OT layers.

FIG. 10 is a schematic topology drawing showing the isolation and pre-recovery under difference scenarios and corresponding recovery and assessment stages.

FIG. 11 is a schematic topology drawing showing an example for the voltage inference-based graph partitioning strategy for detection and localization.

FIG. 12 is a schematic topology drawing showing the draft partitioning algorithmic steps for the modified IEEE 13-node distribution feeder.

FIG. 13 is a pseudocode showing the balanced graph partitioning (BGP) algorithm used in the system.

FIG. 14 are graphs showing 4-manifold surfaces comparing the inferred voltage to actual voltage.

FIG. 15 are graphs showing 4-manifold surfaces for actual and reactive nodal injection differences.

FIG. 16 are graphs showing 4-manifold surfaces for conditions as displayed in the graphs.

FIG. 17 is a graph showing the loadability factor for a time period and showing a random distribution.

FIGS. 18A-18C are graphs showing the real-time detection and localization at various stages for the 13-node feeder in a first scenario.

FIGS. 19A-19C are graphs similar to that shown in FIG. 18, but for a second scenario.

FIGS. 20A-20G are graphs showing the real-time detection and localization depicted at various stages.

FIG. 21 is a schematic chart showing the post-attack restoration framework.

FIG. 22 is a schematic drawing showing the IBR cyber network.

FIGS. 23 and 24 are some of the equations used in the model formulations for a load status and grid related constraints in FIG. 23 and the deterministic model in FIG. 24.

FIG. 25 is a flow sequence showing the development of an ambiguity set.

FIGS. 26-27 are equations used in the formulations of the DRO model.

FIG. 28 is a pseudocode for a gradient descent search algorithm used with the system.

FIG. 29 are equations used in the formulation for the DRO model as a traceable optimization problem.

FIG. 30 is a pseudocode of the C and CG algorithm.

FIG. 31 is a schematic topology drawing showing the sub-grid strategy and the 13-node test cases with the top showing that cyber network and the bottom showing the physical network.

FIG. 32 is a graph showing the probability range of the attack scenario in the 13-node test cases.

FIG. 33 are bar charts showing the IBR output power in two 13-node test cases.

FIG. 34 is a table showing the load pick-up in the two 13-node test cases.

FIG. 35 is a chart showing the comparisons of the DRO model and a conventional restoration method.

FIG. 36 is a schematic topology drawing showing the cyber network of the 123-node test system.

FIG. 37 is a graph showing the probability range of an attack scenario in the 123-node test system.

FIG. 38 is a table showing the load pick-up in the 123-node test cases.

FIG. 39 are graphs showing the sensitivity analysis in the 123-node test cases.

FIG. 40 is a block diagram showing another example of the system operational framework for the cyber threats.

FIG. 41 is a chart showing a DRO-based survivability enhancement model.

FIG. 42 is a block diagram of an excerpt of a DOS attack duration.

FIG. 43 is a schematic topology drawing of the cyber network topology in a 13-node test feeder.

FIG. 44 is a table showing cases and scenarios in the 13-node test feeder.

FIG. 45 are bar charts showing the survivability of the 13-node test feeder in three test cases.

FIG. 46 is a graph showing the comparison as an empirical distribution of the Wasserstein Ball and kernel-based ambiguity sets.

FIG. 47 is a table showing the components and their location in the 123-node test feeder.

FIG. 48 is a schematic topology drawing showing the cyber network of the 123-node test feeder.

FIG. 49 is a table showing the system survivability in the 123-node test cases.

FIG. 50 are pie charts showing the system states and percentages in three test cases.

FIG. 51 is a graph showing the possibility range of the ambiguity set in the 123-node test case under different values.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

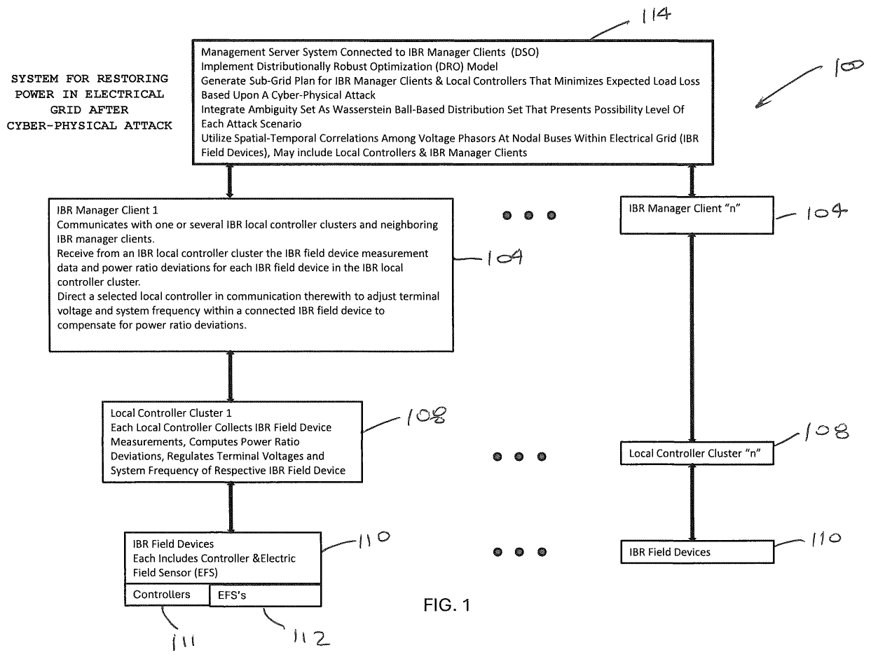

Referring now to FIG. 1, there is generally illustrated at 100 a system for restoring power in an electrical power system from a cyber-physical attack. The system includes IBR manager clients 104 that communicate with one or several IBR local controller clusters 108 and neighboring IBR manager clients. Each IBR manager client 104 receives from an IBR local controller cluster 108 the IBR field device measurement data and power ratio deviations for each IBR field device 110 in the IBR local controller cluster, and direct a selected local controller in communication therewith to adjust terminal voltage and system frequency within a connected IBR field device to compensate for power ratio deviations. IBR field devices each include a controller 111 and electric field sensor 112. Each local controller collects IBR field device measurements, computes power ratio deviations, regulates terminal voltages and system frequency of respective IBR field devices.

A management server system 114 is connected to IBR manager clients 104 and implements a Distributionally Robust Optimization (DRO) model that generates a sub-grid plan for IBR Manager Clients and local controllers 111 and minimizes expected load loss based upon a cyber-physical attack. It integrates an ambiguity that is set as a Wasserstein ball-based distribution set that presents a possibility level of each attack scenario. It also utilizes spatial-temporal correlations among voltage phasors at nodal buses defined by the electrical grid and the IBR field devices 110, and may include local controllers 111 and IBR manager clients 104.

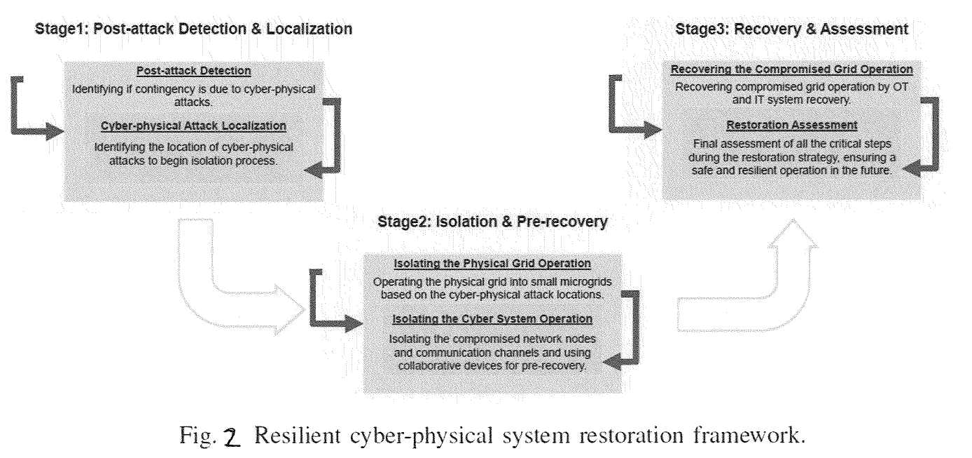

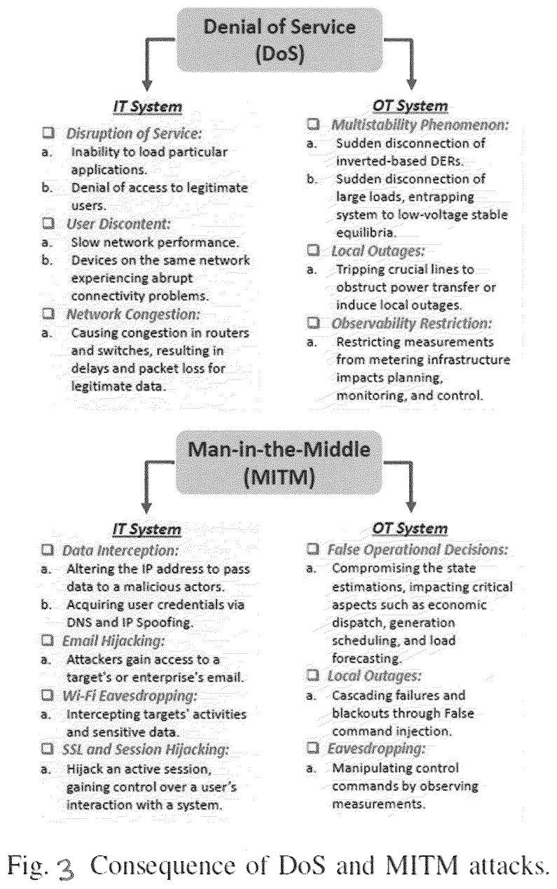

A resilient CPS restoration framework is depicted in FIG. 2, which includes three interconnected stages. A detailed overview of each stage follows.

Stage 1: Post-Attack Detection & Localization. In this initial phase, the system verifies whether observed consequences like faults or outages result from a cyber-physical attack. Once a cyber-physical attack is confirmed, subsequent steps involve localizing the attack's path within both Information Technology (IT) and Operational Technology (OT) layers and understanding the nature of the attack. This stage establishes a thorough assessment of the cyber-physical attack, laying the foundation for subsequent restoration stages.

Stage 2: Isolation & Pre-Recovery. Building on insights from the previous stage, this phase utilizes information about compromised IT/OT nodes, communication links, attack nature, and attack path to devise an effective isolation strategy. It may include actions such as isolating the physical grid operation into small microgrids, segmentation of the cyber layer and more. The pre-recovery steps in this stage allocate resources to bring the grid operation back to the pre-attack state by utilizing collaborative intelligent electronic devices (IEDs), rerouting cyber communication, or deploying Distributed Energy Resources (DERs) and Inverter-Based Resources (IBRs) to prepare for black-start and energization.

Stage 3: Recovery & Assessment: In the concluding stage, the recovery steps are focused on reinstating compromised grid functions, particularly observability and controllability. The emphasis is on recovering grid operations in terms of observed consequences such as faults, load restoration, or black start. The assessment during this restoration phase aims to ensure a secure and resilient operation for the future.

The proposed framework offers a systematic approach to restoration under cyber-physical attacks, ensuring resilient power grid operation. Some details about the mathematical metrics quantifying the efficacy of each restoration stage are described below. Various steps are considered before initializing the restoration strategy.

Attack Verification. A challenge is to determine whether the fault or outage results from a cyber-physical attack on the electrical grid. This step is important as contingencies can also arise from equipment failures, software bugs, or natural disasters like earthquakes, wildfires, hurricanes, and similar events.

Attack Consequences. This step establishes connections between potential contingencies or faults in both IT and OT systems with each attack type. It aims to develop an understanding of how different attack types can have overlapping impacts or consequences.

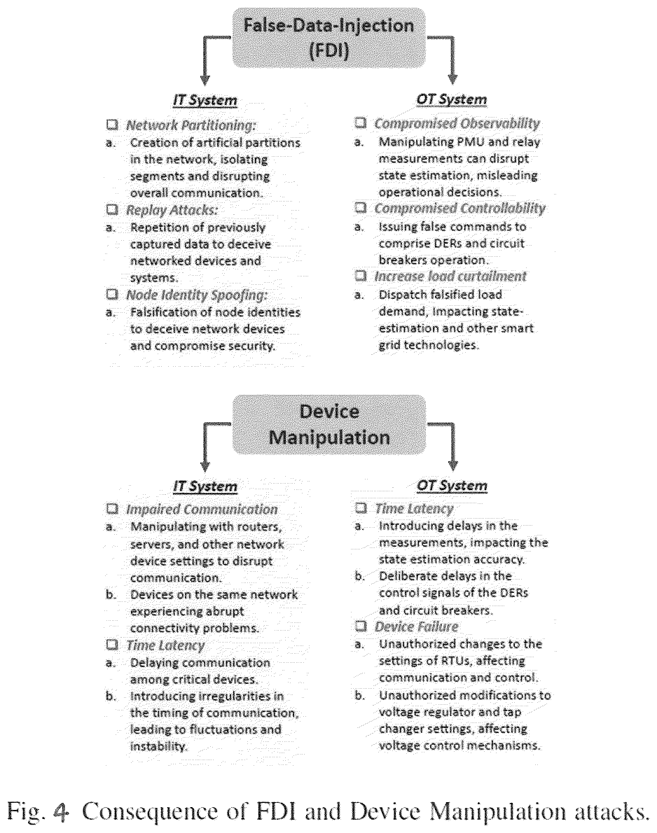

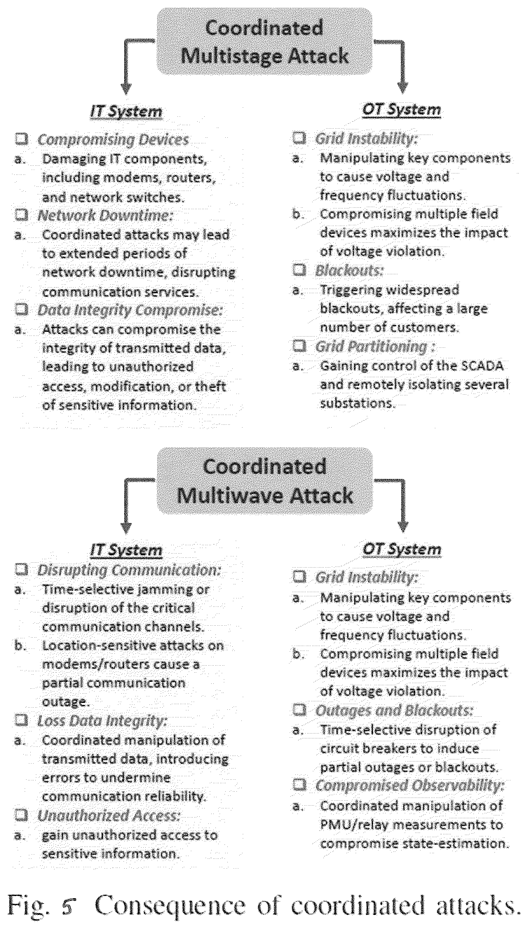

A summary of Denial of Service (Dos) and Man-in-the-Middle (MITM) attacks' consequences is shown in FIG. 3, and FIG. 4 covers the impact of False-data-Injection (FDI) and device manipulation attacks. FIG. 5 outlines the consequences of coordinated attacks on both IT and OT systems, offering comprehensive insights into the impacts associated with various attack types. The examples of coordinated attacks are the multistage and multiwave attacks. Multistage attacks involve interrelated steps, where each depends on the success of the previous one. Multiwave attacks are coordinated spatially and temporally, with attackers compromising the cyber system and strategically launching consecutive attacks on specific devices at different times.

Initial Response Guidelines. These guidelines serve as a general operational procedure for the initial response team. They aid in thoroughly assessing the system, verifying if the fault or outage is due to a cyber-physical attack, and narrowing down potential attack types and possible attack paths. In the event of a cyber-physical attack on active distribution grids, the initial response guidelines are summarized as follows:
1) Promptly activate the initial response team when there are suspicions of cyber-physical breaches;
2) Identify potential signs of cyber-physical attacks and initiate thorough inspections of both IT and OT systems;
3) Declare a cyber-physical attack and initiate alerts via the Advanced Distribution Management System (ADMS);
4) Deploy detection algorithms to verify attack path, location, and attack nature in both IT and OT systems; and
5) Carefully examine the affected system to gain insights into the motive behind the attacker's actions.

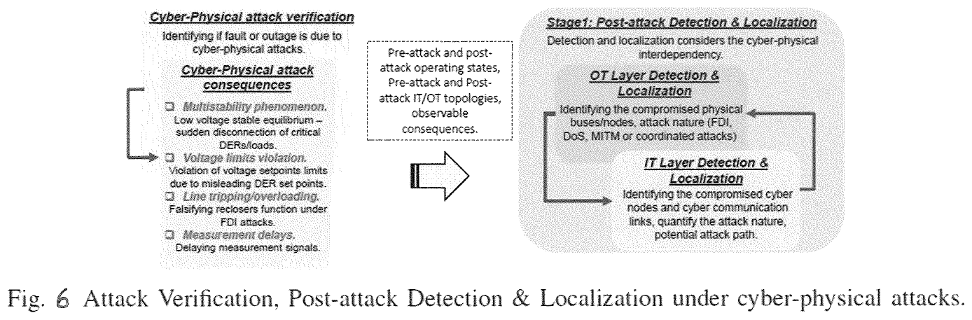

Post-Attack Detection & Localization. FIG. 6 depicts a cyber-physical attack verification, post-attack detection, and localization process. An example scenario may occur when the Distribution System Operator (DSO) as part of the system 100, and in an example, corresponding to the management server system 114 observes some consequences, as shown in FIG. 6. Based on these observations, the DSO initiates Stage 1 of the restoration framework, incorporating information about system operating states, IT/OT topologies from pre-attack and post-attack instances, and observable consequences. Following an initial response, Stage 1 executes detection and localization accounting for cyber-physical interdependency.

The detection and localization algorithm begins by screening the OT layer to identify compromised nodes and ascertain the nature of the attack. This information is then used to identify compromised cyber nodes, communication channels in the IT layer, and potential attack paths. This interdependent post-attack detection and localization model not only identifies compromised locations in both IT/OT layers but also offers insights into potentially vulnerable locations for future attacks. For example, the proposed Voltage Inference framework may be applied to provide the observability and situational awareness of both IT and OT networks.

Isolation & Pre-Recovery. After the verification of the cyber-physical attack and the identification of compromised IT/OT nodes, the next restoration stage is “Isolation & Pre-recovery”as illustrated in FIG. 7. This stage integrates information from the previous stage regarding compromised locations in IT/OT layers, attack paths, and attack nature. The isolation procedure within this stage partitions the physical grid operation into small microgrids, discerning between uncompromised and compromised energized sections of the grid.

Additionally, this step examines whether the attackers intended to compromise grid observability, controllability, or both. The pre-recovery steps in this stage evaluate the resources necessary for the recovery phase, including collaborative IEDs for observability or controllability and resources for re-energizing the compromised grid sections.

For example, the adaptive restoration strategies can prepare IT and OT systems for responding to different types of coordinated cyber-physical attacks.

Recovery & Assessment. The last stage in the restoration procedure is “Recovery & Assessment.” The recovery steps pursue two primary objectives: i) reinstating compromised grid functions, such as observability, controllability, or both; and ii), restoring compromised grid operations where observed consequences have transpired. The assessment steps play a crucial role in ensuring a secure and resilient future operation by examining the robustness of each stage within the restoration framework. For example, a decentralized restoration strategy can harness the grid-forming IBRs to black start, stabilize and establish the network. However, the cyber layer should also be considered, as well as the uncertainty of attack surfaces, to avoid any compromised node to cause further damage.

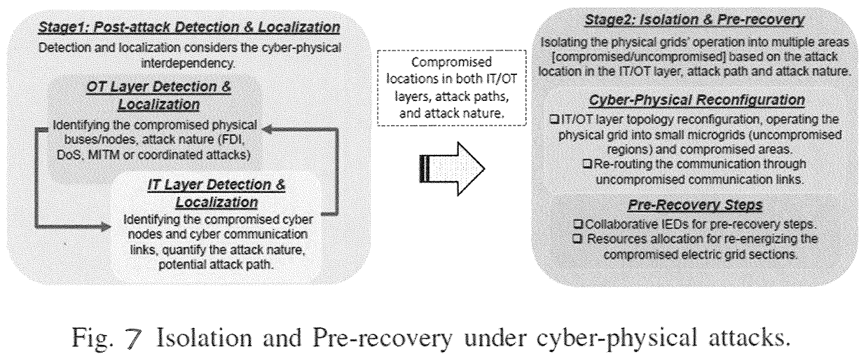

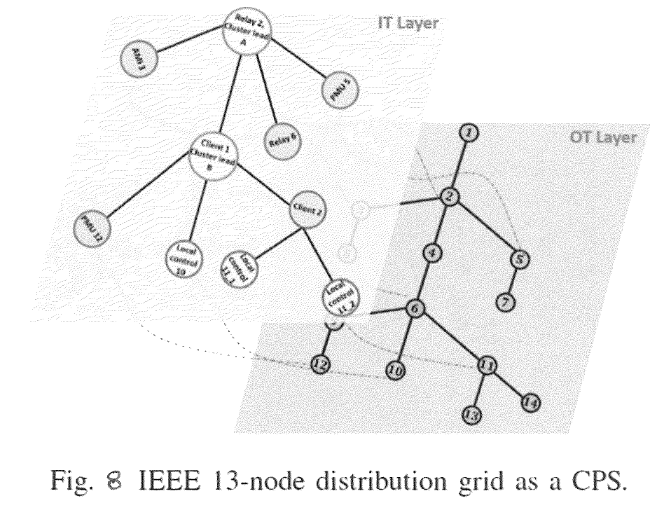

An example restoration node under cyber-physical attacks is now described. An IEEE 13-node distribution feeder with a distributed IT layer is shown with a Cyber-Physical System (CPS) in FIG. 8. The IT layer comprises cluster leads A and B, responsible for data collection, control dispatch, and inter-cluster communication. It is possible to assume that at time tₖ with k∈Z, the pre-attack operating state and IT/OT topologies are known, and at time step tₖ₊₁ the DSO observes some of the consequences mentioned above. Initially, the restoration approach executes “Post-attack Detection & Localization” for the OT layer, utilizing the Voltage Inference-based partitioning approach as shown in FIG. 9. The distribution feeder may be an undirected graph G(N, E) with N and E representing nodes and edges, and observable buses include 5, 9, 10, and 12. This procedure divides G into subgraphs G_1(N_1, E_1) and G_2(N_2, E_2) at interfacing node 6, ensuring equal distribution of observable buses. If the inference does not hold at interfacing bus 6, either subgraph may contain compromised buses. This graph partitioning procedure iterates, dividing previously segmented subgraphs and performing inference at interfacing nodes until the compromised buses are identified. The information from the OT layer is then used to identify compromised cyber nodes/links and potential attack paths in the IT layer. FIG. 9 illustrates multiple scenarios for IT layer detection and localization based on the compromised nodes' locations in the OT layer.

Given the state of the observed consequences/faults and the location of attacked nodes/links in the IT/OT layer, the isolation may look different from case to case. This Isolation & Pre-recovery stage incorporates information about compromised locations from IT/OT layers, attack nature, and attack path to determine the optimal isolation strategy and pre-recovery steps.

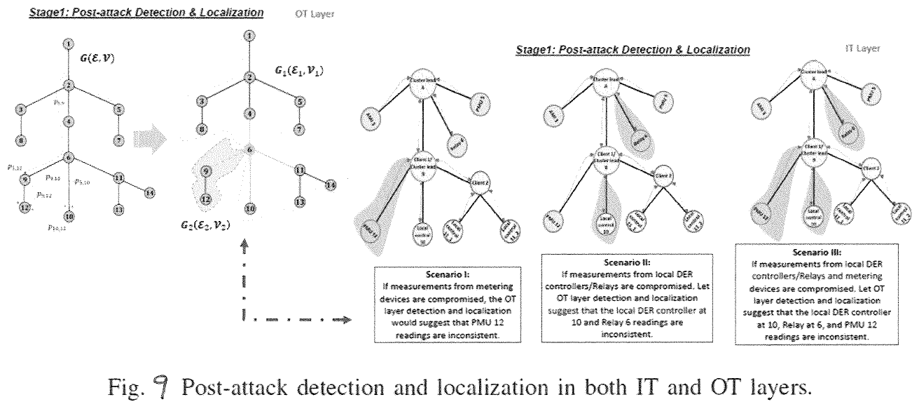

FIG. 10 portrays isolation under various IT/OT detection & localization scenarios, and Recovery & Assessment under various scenarios. These scenarios capture recovery under different compromised grid functionalities, addressing observability, controllability, or both, along with recovery of grid operations concerning observed consequences and faults, such as load restoration and black start.

These are challenges and opportunities with cyber-physical attack detection and localization. There is some electrical grid vulnerability to data integrity attacks, employing a principal component analysis-based algorithm to detect malicious modification of network data in an accessible database. Another system considers the cybersecurity of large-scale smart grids against false data injection attacks (FDIA) via an internal observer-based approach. Some proposals model power grid dynamics, analyze the stealthy characteristics of FDIA, introduce an interval observer for estimating the interval state, and employ a logic localization judgment matrix to identify the attack location. However, these approaches may encounter accuracy challenges from external disturbances, and there is a trade-off between false alarm rates and missed detection rates when using pre-computed detection thresholds.

An adaptive hierarchical strategy for cyber-attack localization in active distribution systems has been proposed. It utilizes electric waveform signals from waveform measurement unit sensors to capture subtle abnormal features. The hierarchical architecture divides the network into sub-groups, enabling cyber-attack localization within local clusters through a modified unsupervised clustering method and a deep learning-based anomaly detection technique tailored for active distribution systems. The precise attack location is determined by analyzing the impact score of each sensor in potential sub-regions. This methodology, however, may produce misleading alerts if anomalous electric waveform features stem from contingencies other than cyber-attacks. The reliance on well-tuned model parameters and potential challenges in generalizing to diverse attack scenarios can impact the approach's efficacy.

Machine learning and artificial intelligence techniques hold significant promise for detecting and localizing cyber-physical attacks in power systems. Notably, the presented approach employs a graph neural network to address the detection and localization of FDIA in power systems.

Some proposed systems have several limitations: i) computational tractability requiring complex implementation, ii) reliance on well-tuned parameters, which limits the application across di-verse attack scenarios, and iii) scalability challenges for large-scale systems. Additionally, a trade-off exists between detection and localization improvements, emphasizing the need for a systematic approach to ensure comprehensive security.

In accordance with a non-limiting example, the system, such as shown in FIG. 1, allows real-time detection and localization of cyber-physical attacks in active distribution grids. The distributed nature of the voltage inference framework is used. The inference relies on a mathematical model of the multiphase distribution grid. It involves a two-step process: a prediction step utilizing a Multivariate Taylor series, and a corrector step aimed at minimizing estimation errors. This combined process allows for the inference of unknown voltage phasors from available measurements.

The inference approach is computationally tractable, relying solely on standard elements of power flow model. It is insensitive to the well-tuned modal parameters, as the approach exploits the underlying mathematical correlation among spatial-temporal measurements. Moreover, the Voltage Inference manifests a distributed architecture, where a cluster or sub-cluster of buses with observability can perform inference independently, making it scalable for large-scale systems.

The strategy begins with a multi-stage partitioning of the grid topology to distribute observable buses relatively equally among partitions. Following this, Voltage Inference is employed in a distributed manner to execute inference from observable buses within clusters and sub-clusters to detect and locate attacks. This approach streamlines communication structures, minimizing information flow and enhancing resilience without requiring centralized control. Additionally, it capitalizes on parallel computing capabilities, effectively reducing the overall computational burden. The proposed strategy incorporates three strategies and/or algorithms as now described.

1) A model-based inference strategy use spatial-temporal correlations among voltage phasors at each bus, considering nodal injections and voltage phasors, to compute unknown voltages from limited measurements.

2) A novel, multi-stage distributed detection and localization strategy uses the Voltage Inference framework deployed across both clusters and sub-clusters of observable buses. This enables real-time localization of compromised measurements for enhanced grid security.

3) A computationally tractable graph partitioning algorithm ensures a balanced distribution of buses with real-time observability among clusters and sub-clusters.

There now follows a further description with various sections, including a mathematical model of unbalanced distribution grid, a voltage inference framework, an outline of the detection and localization strategy based on the voltage inference framework, and simulation results and conclusions.

MATHEMATICAL FORMULATION: A multiphase unbalanced distribution grid can be described as a weakly meshed undirected graph G(E, [symbol] ), where E represents a set of lines (edges) and [symbol] is a set of buses (vertices). For any bus i∈V, A general expression for the i^{th} bus complex voltages

$${V}_{i} = {V}_{i}^{r} + j {V}_{i}^{m}$$

can be written as a function of nodal power injections Sⱼ=Pⱼ+jQⱼ and complex voltage phasors Vⱼ of all the buses in the network (i.e., j=2, 3, . . . , n). The complex branch currents vector I^{b}=[Iᵢⱼ]^{T} is defined as:

I^{b}=[BIBC]Iⁿ (1)

The “BIBC” is a n×n upper triangle matrix containing either “1” or “0.” It is referred to as the Bus-Injection to Branch-Current (BIBC) matrix. While

$${I}^{n} = {[ {( \frac{{P}_{j} + j {Q}_{j}}{{V}_{j}} )}^{*} ]}^{T}$$

is a n×1 vector comprises of complex conjugate of nodal currents. Similar to (1), the expression for the vector of complex nodal voltages Vⁿ=[Vᵢ]^{T} (except for Bus 1, which is a substation bus) can be described as:

Vⁿ=V^{s}−[BCBV]I^{b} (2)

In (2), BCBV is a n×n lower triangle matrix containing line impedances “zᵢⱼ” known as Branch-Current to Bus-Voltage (BCBV) matrix. Whereas I^{b}=[Iᵢⱼ]^{T}=[I₁₂, I₂₃, . . . ]^{T} denotes n×1 vector containing all the branch currents. And V^{s}=[V₁]^{T} is a n×1 vector containing complex voltage phasors of the substation bus. Finally, we can describe a general expression for Vⁿ by substituting (1) into (2):

Vⁿ=V^{s}−[BCBV][BIBC]I^{b}=V^{s}−[Z]Iⁿ (3)

Thus, the complex nodal voltages at any i^{th} bus (except for the substation bus) can be stated as:

$${V}_{i} = {V}_{1} - {\sum }_{j = 2}^{n} {𝒵}_{ij} {I}_{j}^{n} \qquad ( 4 )$$

Here, Z=[BCBV][BIBC]∈ [symbol] is a dense matrix with complex entries. It is observable from (4) that voltage phasor Vᵢ is a function of nodal power injections Sⱼ=Pⱼ+jQⱼ. Here, Pⱼ and Qⱼ denote the active and reactive powers, respectively. As a result, any change in power injections at any bus will induce voltage variations across all buses within the distribution grid. The dynamic nature of distributed loads and renewable generation leads to evolving spatial-temporal voltage profiles in the distribution network. However, real-time monitoring of these voltage variations is limited due to partial observability, impacting the effective management of smart grid technologies.

The following section presents a distributed inference approach to identify the highest and lowest voltage levels in distribution grid despite the challenges of partial observability.

VOLTAGE INFERENCE FRAMEWORK: A novel inference concept referred to as “Voltage Inference” is formulated to address the challenges posed by limited observability. The framework comprises two main steps: i) a prediction step utilizing the Multivariate Taylor series approximation, and ii) a corrector step aimed at minimizing estimation residual to infer the unknown voltages based on the available measurements. This approach enhances the observability in scenarios where complete voltage information is unavailable.

A. Perturbations and Taylor's Theorem. Let the complex voltage at the i^{th} bus be:

$${V}_{i} ( {P}_{j} , {Q}_{j} ) = {V}_{1} - {\sum }_{j = 2}^{n} {{𝒵}_{i j} ( \frac{{P}_{j} + j {Q}_{j}}{{V}_{j}} )}^{*} \qquad ( 5 )$$

Since the i^{th} bus complex voltage Vᵢ(Pⱼ, Qⱼ) is a function of both Pⱼ and Qⱼ (with j=2, 3, . . . , n), (5) can be expanded using the Multivariate Taylor series as:

$${V}_{i} ( {P}_{j} + Δ {P}_{j} , {Q}_{j} + Δ {Q}_{j} ) = {V}_{i} ( {P}_{j} , {Q}_{j} ) + {\sum }_{j = 2}^{n} ( \frac{\partial {V}_{i}}{\partial {P}_{j}} Δ {P}_{j} + \frac{\partial {V}_{i}}{\partial {Q}_{j}} Δ {Q}_{j} ) + R ( {P}_{j} , {Q}_{j} ) \qquad ( 6 )$$

Let \hat{V}ⱼ (x+Δx)=Vᵢ(Pⱼ+ΔPⱼ, Qⱼ+ΔQⱼ) with x=[Pⱼ, Qⱼ]^{T} and Δx=[ΔPⱼ, ΔQⱼ]^{T}. Then we can write the approximate \hat{V}ᵢ(x+Δx) using 1^{st} order Multivariate Taylor series as:

$${\tilde{V}}_{i} ( x + Δ x ) \approx {V}_{i} ( x ) + [ \frac{\partial {V}_{i}}{\partial {P}_{j}} \frac{\partial {V}_{i}}{\partial {Q}_{j}} ] Δ x \qquad ( 7 )$$

The term R(Pⱼ, Qⱼ) is the truncation error of the 1^{st} order Multivariate series approximation (7) around Vᵢ(x). In the real-time operation, due to the intermittency of renewable generations and the variability of loads, system states at time tₖ will change from S(tₖ) to a new state S(tₖ₊₁) at time tₖ₊₁. It means the system operating state shifts to a new state, i.e., (Pⱼ(tₖ), Qⱼ(tₖ))→(Pⱼ(tₖ₊₁), Qⱼ(tₖ₊₁). It will cause the nodal voltages to also change from Vⁿ(tₖ) to Vⁿ(tₖ₊₁).

Monitoring real-time voltages at every bus poses a challenge due to the lack of real-time metering infrastructure across distribution networks. To overcome this observability issue, an inference framework uses available real-time measurements along with sensitivity information to infer the otherwise unknown voltages.

A. Prediction Step—Multivariate Taylor Series. The first step in the inference framework is prediction. The distribution feeder G(E, [symbol] ) includes two distinct bus sets: i) the observable buses set with real-time measurements of Pⱼ, Qⱼ, and Vᵢ, ∀j∈ [symbol] ), and ii) the unobservable bus set with no real-time measurements of Pⱼ, Qⱼ, and Vᵢ, ∀j∈ [symbol] ). Where [symbol] and [symbol] denote the observable and unobservable bus sets, respectively.

To predict voltages, the system 100 assumes that Distribution System Operator (DSO) 114 routinely establishes a pre-contingency system state as a benchmark or baseline for solving power flow, optimal power flow, or executing contingency analysis. This baseline state is configured to accommodate various time frames, allowing it to capture the system's dynamic behavior. Based on this practice, at time interval to, a system state is known, including both nodal power injections (i.e., Pⱼ(t₀) and Pⱼ(t₀)$ and the complex voltage phasors Vⱼ(t₀), ∀j∈ [symbol] . This system state serves as a reference or benchmark system state by the DSO 114.

In real-time operations, system states continuously evolve at discrete time intervals δt. Let tₖ=t₀+δt, where t₀ describes timeline for the reference system state, and tₖ represents a continuously evolving time frame, k∈Z⁺. At time tₖ, measurements are available only at observable buses due to the partial observability in distribution grids. To predict the complex nodal voltages at the unobservable locations within [symbol] , the inference leverages the Multivariate Taylor series approximation (6). This approach integrates information related to previously known baseline system states and sensitivities around t₀, in conjunction with the real-time measurements taken at tₖ for observable buses, as outlined below:

$${V}_{a} ( {t}_{k + 1} ) \approx {V}_{a} ( {t}_{k} ) + {[ \frac{\partial {V}_{a}}{\partial {P}_{b}} \frac{\partial {V}_{a}}{\partial {Q}_{b}} ]}_{t = {t}_{k}} Δ \hat{x} ( {t}_{k} ) \qquad ( 8 )$$

In (8), indices “a” and “b” denote a set of unobservable and observable buses in the network, respectively. Here, Δ\hat{x}(tₖ)=[ΔP_{b}(tₖ), ΔQ_{b}(tₖ)]^{T}. The expressions

$$\frac{\partial {V}_{a}}{\partial {P}_{b}} and \frac{\partial {V}_{a}}{\partial {Q}_{b}}$$

denote sensitivities of the unobservable bus set complex nodal voltages w.r.t nodal injections of the observable set. The analytical sensitivity expressions can be obtained by differentiating (4) with P_{b} and Q_{b} respectively.

Since the complex voltage Vᵢ(Pⱼ, Qⱼ) is a function of the nodal injections (i.e., Pⱼ and Qⱼ) at all the buses in the network, it is reasonable to assume that the prediction \hat{V}ₐ(tₖ₊₁) can be made using (8) In the proposed prediction, the truncation error can be defined as:

$$R ( {P}_{j} , {Q}_{j} ) = {[ \frac{\partial {V}_{a}}{\partial {P}_{b}} \frac{\partial {V}_{a}}{\partial {Q}_{b}} ]}_{t = {t}_{k}} Δ \tilde{x} ( {t}_{k} ) + {\sum }_{κ = 1} {\sum }_{j = 2} \frac{1}{( κ + 1 ) !} Δ {{x}^{( κ )} ( {t}_{k} )}^{⊤} + {[ \frac{{\partial }^{( κ + 1 )} {V}_{a} ( ξ )}{\partial {( {P}_{j} )}^{( κ + 1 )}} \frac{{\partial }^{( κ + 1 )} {V}_{a} ( ξ )}{\partial {( {Q}_{j} )}^{( κ + 1 )}} ]}_{t = {t}_{k}} Δ {x}^{( k )} ( {t}_{k} )$$

Where, Δ\tilde{x}(tₖ)=[ΔPₐ(tₖ), ΔQₐ(tₖ)]^{T}. Vₐ(ξ)∈c exist between Vₐ(tₖ) and Vₐ(tₖ₊₁)

Corrector Step-Minimizing the Loss. The \hat{V}ₐ(tₖ₊₁) is an estimate of the actual voltages at the unobservable bus set in the network. Therefore, a corrector step ensures the predicted voltages \hat{V}ₐ(tₖ₊₁) are close to the actual voltages of the unobservable locations. Subsequently, an optimization problem is solved that minimizes a residual based on the differences between the predicted complex nodal injections at the observable bus set, i.e.,

$${S}_{b}^{*} ( {\hat{V}}_{a} ( {t}_{k + 1} ) ) ,$$

and actual measurement values

$${S}_{b}^{*} ( {t}_{k + 1} ) ,$$

resulting in a more refined estimate for \hat{V}ₐ(tₖ₊₁). The complex conjugate of nodal power injection set is a function of complex voltage phasors:

S*(Vⱼ)=D[(Vⁿ)*]Z⁻¹ΔV (9)
where, ΔV=V^{s}−Vⁿ and D[(Vⁿ)*] is a n×n diagonal matrix, with diagonal entries representing the complex conjugate of voltage phasors. Let, [symbol] = [symbol] , then the i^{th} bus complex conjugate of nodal power injection

$${S}_{i}^{*}$$

is:

$${S}_{i}^{*} ( {V}_{j} ) = {V}_{i}^{*} {\sum }_{j = 2}^{n} {𝓎}_{ij} Δ {V}_{j} \qquad ( 10 )$$

Using the above equation, the estimate for the complex conjugate of nodal injection at the observable bus set “b” can be defined as:

$${\hat{S}}_{b}^{*} ( {\hat{V}}_{a} ) = {V}_{b}^{*} {\sum }_{j = 2}^{n} {𝓎}_{bj} Δ {\hat{V}}_{j} \qquad ( 11 )$$

In the above equation, Δ\hat{V}ⱼ is embedded with \hat{V}ₐ. If the predicted voltages \hat{V}ₐ(tₖ₊₁) are close to the actual voltages Vₐ(tₖ₊₁), then the estimate

$${\hat{S}}_{b}^{*} ( {\hat{V}}_{a} ( {t}_{k + 1} ) )$$

should also be comparable to the

$${S}_{b}^{*} ( {t}_{k + 1} ) .$$

The following residual is proposed:

$$r ( {\hat{V}}_{a} ( {t}_{k + 1} ) ) = [ {\hat{S}}_{b}^{*} ( {\hat{V}}_{a} ( {t}_{k + 1} ) ) - {S}_{b}^{*} ( {t}_{k + 1} ) ] \qquad ( 12 )$$

It is possible to solve the following optimization problem to find the best solution for \hat{V}ₐ(tₖ₊₁) by minimizing the residual in the above equation (12):

$${min}_{{\hat{V}}_{a}} \frac{1}{2} {‖ r ( {\hat{V}}_{a} ( {t}_{k + 1} ) ) ‖}_{2}^{2} \qquad ( 13 )$$

Given that the formulation (13) is an unconstrained optimization problem with a smooth objective function, the gradient descent algorithm is applied to solve the optimization problem. It is important to highlight that the framework is equally applicable to a multiphase unbalanced distribution grid. The key features are as follows: i) it manifests a distributed architecture that enables independent inference from each or a cluster of observable buses; ii) this configuration simplifies the communication structure and minimizes the information flow, establishing a more resilient framework that operates without centralized control; and iii) the distributed approach leverages parallel computing capabilities, reducing the overall computational burden.

An innovative strategy for real-time detection and localization of compromised buses using the distributed nature of the voltage inference framework is now described.

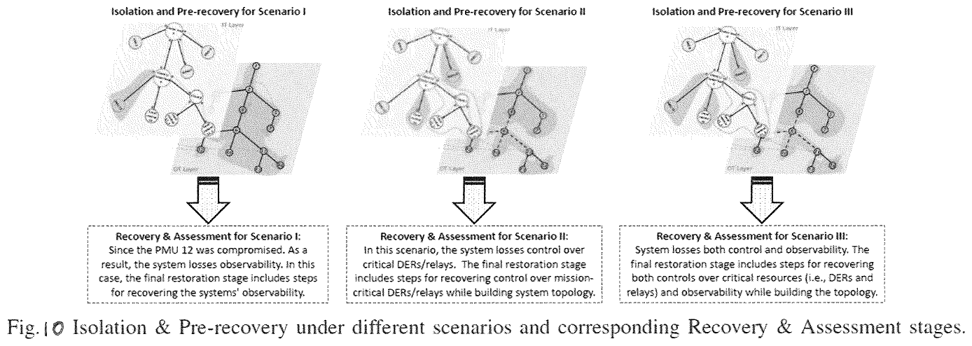

DETECTION AND LOCALIZATION ILLUSTRATION. The detection and localization concept is introduced based on the voltage inference as illustrated in FIG. 11.

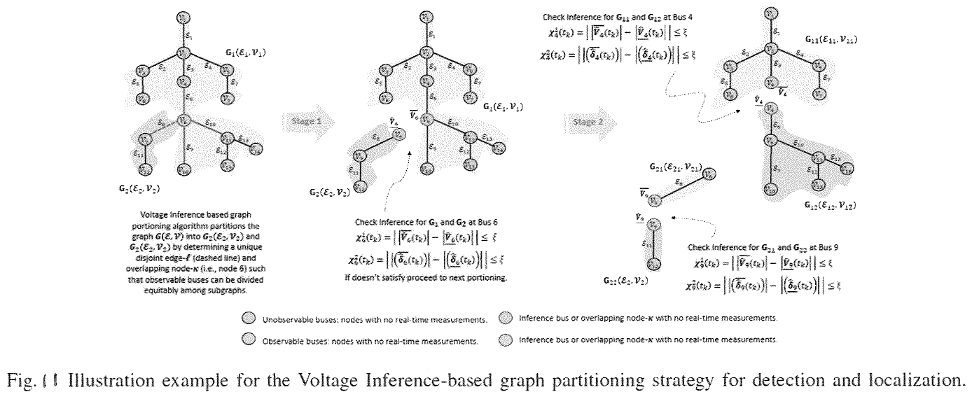

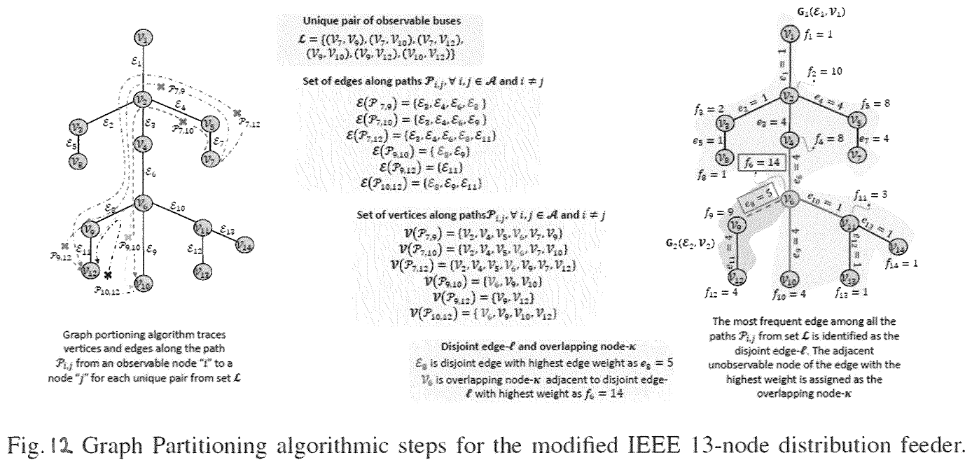

Voltage Inference-based Detection. Let the distribution feeder be an undirected graph G(E, [symbol] ) with E={E₁, E₂, . . . , E₁₃} and [symbol] ={ [symbol] ₁, [symbol] ₂, . . . , [symbol] ₁₄}, as depicted in FIG. 12. The graph G(E, [symbol] ) represents a modified IEEE-13 bus distribution feeder with observable buses set [symbol] as [symbol] ₇, [symbol] ₉, [symbol] ₁₀, and [symbol] ₁₂. The DSO designates a baseline system state at t₀, which serves as a pre-contingency system state. During real-time operations, the voltage inference-based partitioning strategy executes the following steps at each instance of time, tₖ with k∈Z⁺, to narrow down the location of the compromised observable buses from the set [symbol] .

The graph partitioning strategy first breaks the graph G(E, [symbol] ) into two subgraphs, G₁(E₁, [symbol] ₁) and G₂(E₂, [symbol] ₂), allowing the set [symbol] to be somewhat equally placed among G₁ and G₂. This results in a distinct disjoint edge “ [symbol] ” and corresponding overlapping node “K” (i.e., [symbol] ₁∪ [symbol] ₂=K) such that set [symbol] is relatively equally distributed in subgraph G₁ and G₂. This condition ensures that each subgraph can perform inference at the node-K with minimal disparity. Consequently, if the measurements are not compromised then the following conditions hold at nod-K:

$$\begin{matrix}{χ}_{κ}^{1} ( {t}_{k} ) = ‖ \text{?} ( {t}_{k} ) \vert - \vert \text{?} ( {t}_{k} ) ‖ \leq ξ \\ {χ}_{κ}^{1} ( {t}_{k} ) = ‖ \text{?} ( {t}_{k} ) \vert - \vert \text{?} ( {t}_{k} ) ‖ \leq ξ\end{matrix} \qquad ( 14 )$$

In the above equations, | [symbol] (tₖ)| and | [symbol] (tₖ)| represent magnitudes of the inferred voltage phasors at node-K from subgraphs G₁ and G₂, while [symbol] (tₖ) and [symbol] (tₖ) stand for the corresponding inferred phase angles. Where parameter “ξ” is the upper bound on the numerical error. In the numerical studies, the parameter ξ was set to 10⁻².

For the given test case model, the optimal choice for disjoint edge- [symbol] is E₈ (i.e., the edge between Bus 6 and Bus 9) and the corresponding overlapping node-K is 16 (i.e., Bus 6). This effectively assigns observable bus [symbol] ₅ and [symbol] ₁₀ to G₁, while [symbol] ₉ and [symbol] ₁₂ to G₂. It is important to highlight that the set [symbol] cannot be divided equally into G₁ and G₂ at any other node.

If Voltage Inference (14) is not satisfied at the interfacing node-K, it indicates that either G₁, G₂, or both may contain compromised observable buses. The process iterates by dividing the previously obtained subgraphs, resulting in G₁₁ and G₁₂ for G₁ and G₂₁ and G₂₂ for G₂. It then verifies (14) at the interfacing nodes-K for new partitions until the compromised bus or buses are identified.

Although the proposed Voltage Inference-based partitioning strategy does not rely on a physical grid partition, it presents a unique approach for utilizing clusters and sub-clusters within the distribution grid for real-time inference. The proposed strategy entails several key features:

1) The proposed strategy has a distributed architecture and involves about log₂( [symbol] ) partitioning stages to narrow down the compromised observable bus location.

2) Given fixed observable buses set [symbol] , the graph partitioning can be performed offline to compute subgraphs and their associated interfacing nodes for all stages involved.

3) The distributed configuration simplifies information flow, resulting in a strategy that is resilient to any manipulation.

The next section introduces graph partitioning algorithms to identify the disjoint edge- [symbol] and interfacing node-K, ensuring a nearly equal distribution of observable buses.

Graph Partitioning Algorithm. The main goal of partitioning the undirected graph G(E, [symbol] ) into two subgraphs is to ensure a nearly equal distribution of observable buses among subgraphs G₁(E₁, [symbol] ₁) and G₂(E₂, [symbol] 2). Specifically, the aim is to minimize the absolute difference in the count of observable nodes between G₁ and G₂ while maintaining necessary constraints, like connectivity and upper bound on the observable nodes count among subgraphs.

The algorithm initiates with an undirected weakly meshed graph G(E, [symbol] ), where the initial weights of each edge and vertex are set to one.

eᵢ=1 and fⱼ=1,∀i∈E and j∈V (15)

Where eᵢ and fⱼ represent the weights associated with the i-th edge and the j-th vertex within graph G. After the initialization, the algorithm generates a set of all unique pairs of the observable buses, denoted as [symbol] . For a aₜ number of observable buses, the number of distinct pairs of observable buses are lₜ=aₜ(aₜ−1)/2. The set [symbol] is defined as:

[symbol]

={( [symbol] ᵢ, [symbol] ⱼ): i,j∈ [symbol] , while i≠j}. (16)

Subsequently, for each unique pair from set [symbol] , the algorithm traces a path [symbol] _{i,j} from the i-th observable node to the j. In a tree topology, only a single unique path exists between any two nodes. For any pair i, j∈ [symbol] and i≠j, the set of edges and vertices along the specific path [symbol] _{i,j} can be defined as:

E( [symbol] _{i,j})={{Eₖ,Eₖ₊₁}: adj(i)≤k≤adj(j)} (17)

and

[symbol]

( [symbol] _{i,j})={{ [symbol] ₖ, [symbol] ₖ₊₁}: i≤k≤j}. (18)

Where E( [symbol] _{i,j}) and [symbol] (P_{i,j}) denote the traced edges and vertices along a path P_{i,j} defined between an i-th observable node to the j-th. Simultaneously, the weight of an edge is updated as follow:

eₖ=eₖ+1, if k∈E(P_{i,j}). (19)

Consequently, the edges that frequently appear along the paths P_{i,j} will be assigned higher weights. This identifies potential candidates for the disjoint edge- [symbol] , leading to a more equitable distribution of observable buses among subgraphs G₁ and G₂. Furthermore, the weights of the vertices are updated as:

$${f}_{i} = {\sum }_{k ∈ adj ( i )} {e}_{k} , ∀ i ∈ 𝒱 . \qquad ( 20 )$$

When there are multiple edges with the similar highest weight, the algorithm selects the disjoint edge- [symbol] that minimizes the absolute difference in the count of observable buses, provided that this difference is within a certain upper bound. This can be described mathematically as follows:

$$arg {min}_{ℓ} \vert {\sum }_{i} {{𝒜}_{𝒾}^{1} \sum }_{i} {𝒜}_{𝒾}^{2} \vert \qquad ( 21 )$$

$$subject to \vert {\sum }_{i} {{𝒜}_{𝒾}^{1} \sum }_{i} {𝒜}_{𝒾}^{2} \vert \leq 1$$

Where [symbol] and [symbol] represents the set of observable buses in G₁ and G₂, respectively. The (21) identify the optimal disjoint edge- [symbol] ensuring that the difference in observable buses is minimized and bounded by 1. This upper bound restricts the feasible choices of edge- [symbol] so that the disparity of observable bus counts among subgraphs is at most one. Given the choice of disjoint edge- [symbol] if there exists an adjacent unobservable vertex, it is identified as the overlapping node-K.

K∈adj( [symbol] ),K≠ [symbol] (22)

FIG. 12 illustrates the steps of the proposed algorithm applied to the IEEE-13 bus example. It effectively demonstrates the algorithm's ability to identify the disjoint edge- [symbol] as E₈ and the corresponding overlapping node-K as [symbol] ₆. Notably, the algorithm selects the edge with the highest weight as the disjoint edge- [symbol] , and the corresponding unobservable vertex serves as the overlapping node-K. A detailed pseudo code for the BGP algorithm is provided in the algorithm of FIG. 13.

NUMERICAL STUDIES. This section tests the performance of proposed strategy on two test networks: 13-node feeder showcasing computational efficiency and 123-node feeder demonstrating scalability.

IEEE 13-node Distribution Feeder. A multiphase unbalanced IEEE 13-node test feeder is shown in FIG. 11. The observable bus set [symbol] comprises Buses [symbol] ₇, [symbol] ₉, [symbol] ₁₀, and [symbol] ₁₂ with real-time measurements. All remaining buses without real-time measurement capabilities belong to unobservable buses set [symbol] . A reference system state is defined at time to using the standard nodal injections. Subsequent time steps tₖ∈[0, 1000s] with a discrete time interval Δt set as one second, the system state evolves from Sⱼ(t₀) to Sⱼ(tₖ) as follows:

Sⱼ(tₖ)=Pⱼ(tₖ)+jQⱼ(tₖ)=λ(tₖ)(Pⱼ(t₀)+jQⱼ(t₀)),∀j∈ [symbol] (23)
where, the parameter λ(tₖ)∈R⁺ represents a scalar loadability factor ranging from 1 to 1.5 with an increment of 0.005 at each time-step tₖ. This indicates that the system operating state Sⱼ(tₖ) evolves from baseline regime Sⱼ(t₀) up to 50% with a proportional increment of about 0.5% at each time-step.

Computational Performance. The initial set of results assess the computational performance of the proposed Voltage Inference framework. In the first scenario, measurements from all observable buses in set [symbol] are used to infer complex voltage phasor at Bus 6, i.e., \hat{V}₆(tₖ). This setup delineates a realistic operational configuration, allowing the operating state Sⱼ(tₖ) to maneuver in multi-dimensional parameter space. Specifically,

$${λ}_{j}^{1}$$

represents loadability factor varying at Buses [symbol] ₅, [symbol] ₁₀, [symbol] ₉, and [symbol] ₁₂, while

$${λ}_{j}^{2}$$

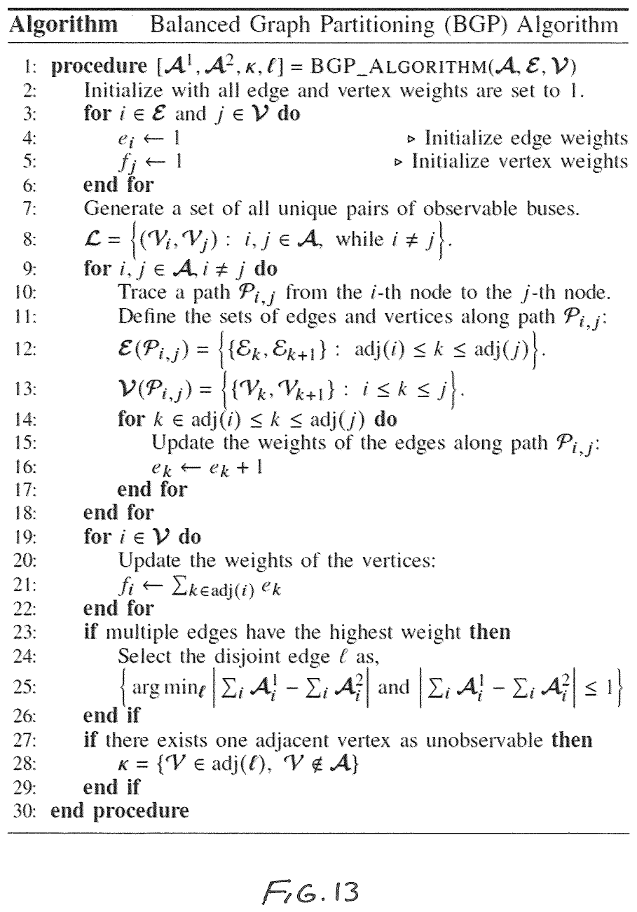

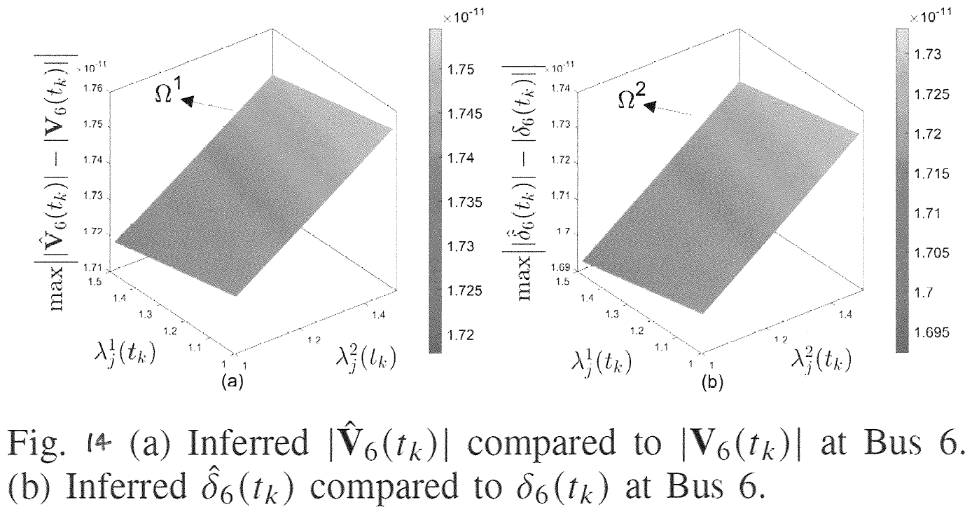

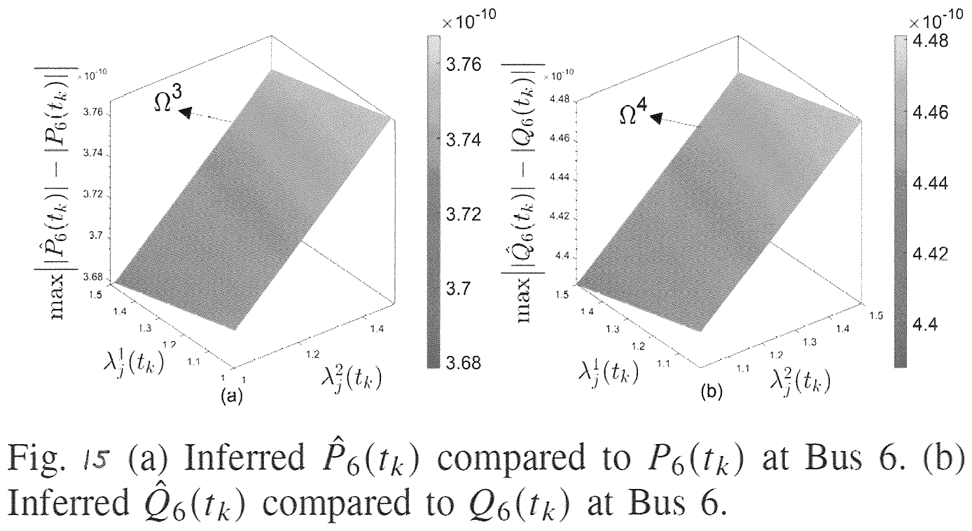

corresponds to loadability factor for the remaining buses. Results for this multi-dimensional setup are illustrated in FIGS. 14 and 15.

FIG. 14 depicts 4-manifold surfaces comparing inferred voltage \hat{V}₆(tₖ) to actual voltage V₆(tₖ), as the operating regime Sⱼ(tₖ) maneuvers in the space of

$${λ}_{j}^{1} and {λ}_{j}^{2} .$$

The first surface Ω¹ illustrates the maximum absolute difference among inferred voltage magnitudes |\hat{V} [symbol] ₆(tₖ)| with actual voltage magnitude |V₆(tₖ)|. The second surface Ω² provides a maximum absolute difference of inferred phase angles \hat{δ}₆(tₖ) with actual phase angles δ₆(tₖ). The corresponding maximum absolute differences in active and reactive nodal injections, when compared with the actual nodal injections at Bus 6, are depicted by the surfaces Ω³ and Ω⁴ in FIG. 15. The Voltage Inference consistently computes the voltage phasor with relatively high accuracy, even in scenarios where the operating regime Sⱼ(tₖ) deviates significantly from the baseline regime Sⱼ(t₀) within multi-dimensional parameter space.

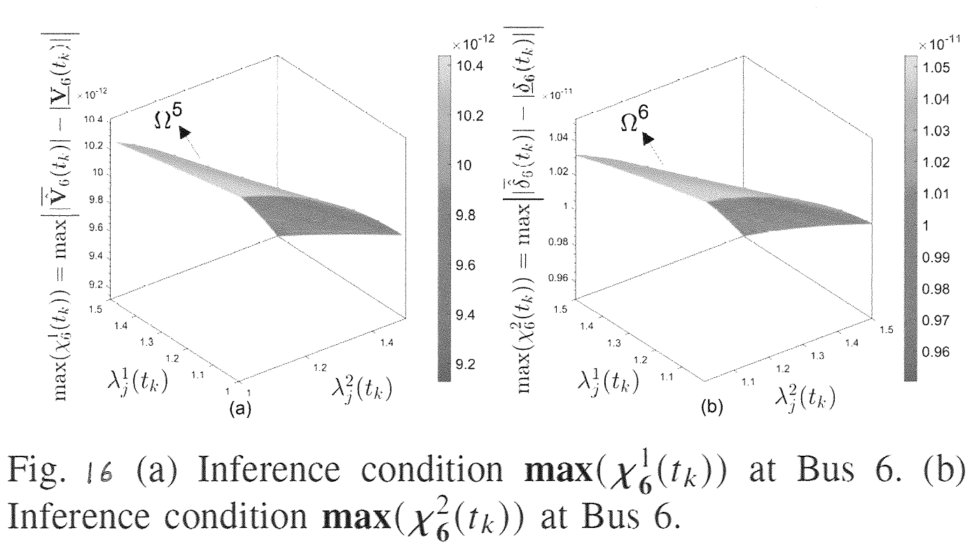

The second set of results evaluate the inference conditions (1) at Bus 6 by employing Voltage Inference as a distributed approach. In this scenario, measurements from two subsets of observable buses, one comprising [symbol] ₇ and [symbol] ₁₀, and the other with [symbol] ₉ and [symbol] ₁₂, are used to infer the complex voltage phasor at Bus 6. FIG. 16 illustrates two distinct surfaces, Ω⁵ and Ω⁶, corresponding to conditions

$${χ}_{6}^{1} ( {t}_{k} ) and {χ}_{6}^{2} ( {t}_{k} ) ,$$

respectively. As Bus 6 is a three-phase bus, these surfaces are plotted for maximum absolute differences. It is visible that both conditions

$${χ}_{6}^{1} ( {t}_{k} ) and {χ}_{6}^{2} ( {t}_{k} )$$

holds with high accuracy at Bus 6 even when only a small subset of observable buses are employed to perform the inference.

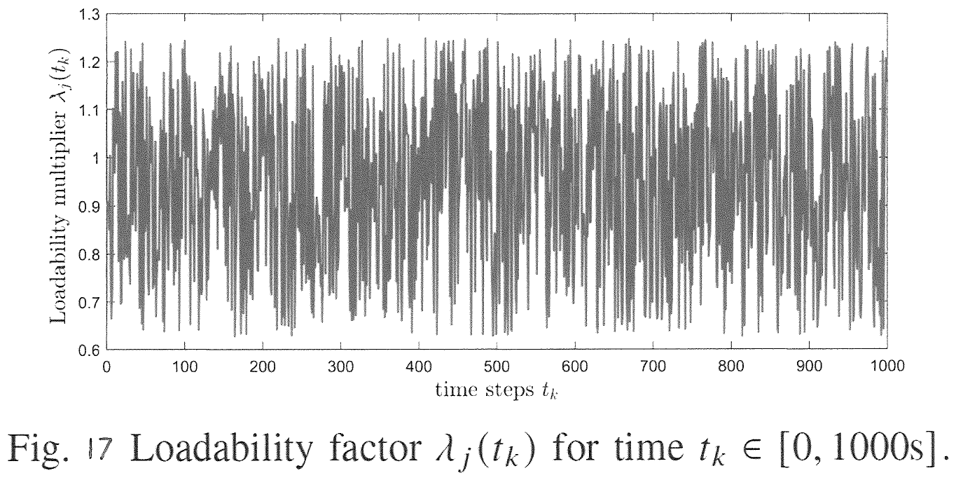

Detection and Localization. Multiple scenarios are considered to evaluate the Voltage Inference-based detection and localization strategy. Computations are performed for tₖ∈[0, 1000s] with a discrete time interval Δt of 1 second. The operating regime Sⱼ(tₖ) evolves from a baseline regime Sⱼ(t₀) based on (9), where the loadability factor λ(tₖ)∈R⁺ adopts a random distribution over tₖ, as shown in FIG. 17. The upper bound for the inference conditions (1) was set to 10⁻⁷. The 13-node system configurations are same as in FIG. 11, with observable buses as [symbol] ₇, [symbol] ₉, [symbol] ₁₀, and [symbol] ₁₂. The attack involves introducing small perturbations to nodal injection and voltage phasor measurements at Bus 7 every 100 seconds, as follows:

$$\begin{matrix}{S}_{7} ( {t}_{k} ) = ( ( {P}_{7} ( {t}_{j} ) + δ {P}_{7} ( {t}_{j} ) ) + j ( {Q}_{7} ( {t}_{j} ) + δ {Q}_{7} ( {t}_{j} ) ) ) \\ {V}_{7 ( {t}_{j} )} = {V}_{7 ( {t}_{j} )} + {δ V}_{7} ( {t}_{j} )\end{matrix} \qquad ( 24 )$$

For all time instances tⱼ within [t₁₀₀, t₂₀₀, . . . , t₁₀₀₀], the system 100 denotes the perturbations corresponding to voltage phasors, active powers, and reactive powers at observable bus 7 as δV₇(tⱼ), δP₇(tⱼ) and δQ₇(tⱼ), respectively. The magnitude of perturbations gradually increases from 1% at t₁₀₀ up to 10%, with a 1% increment every 100 seconds. The first scenario involves manipulating only the nodal injections (10a), and the second scenario exclusively manipulates the voltage phasors (10b). The second scenario ensures that the altered voltage phasor measurements remain within the statutory limits of ±5%.

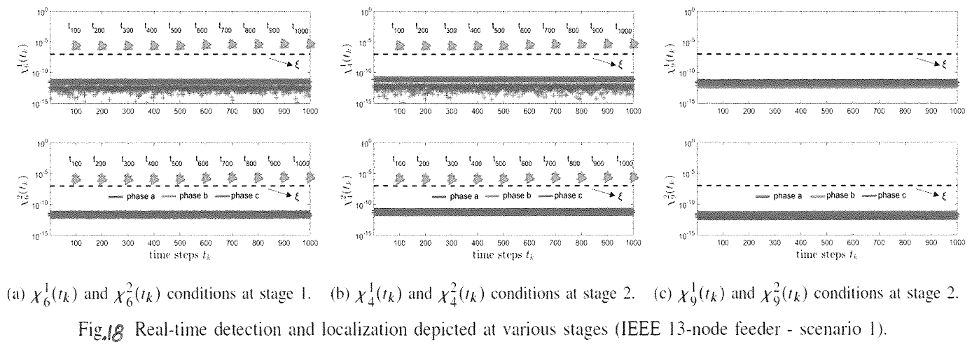

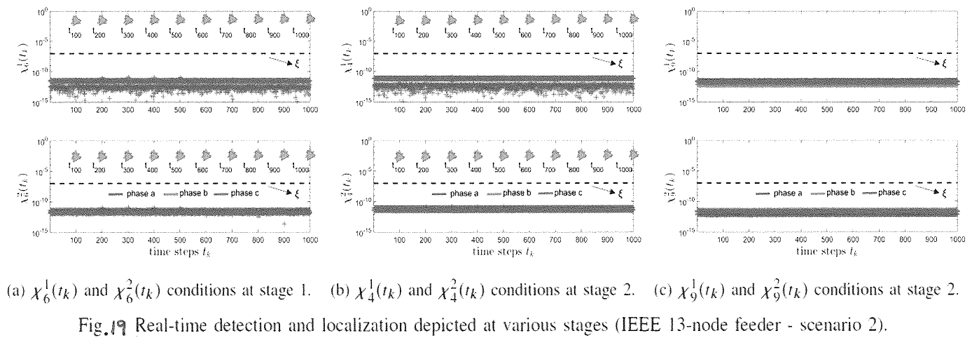

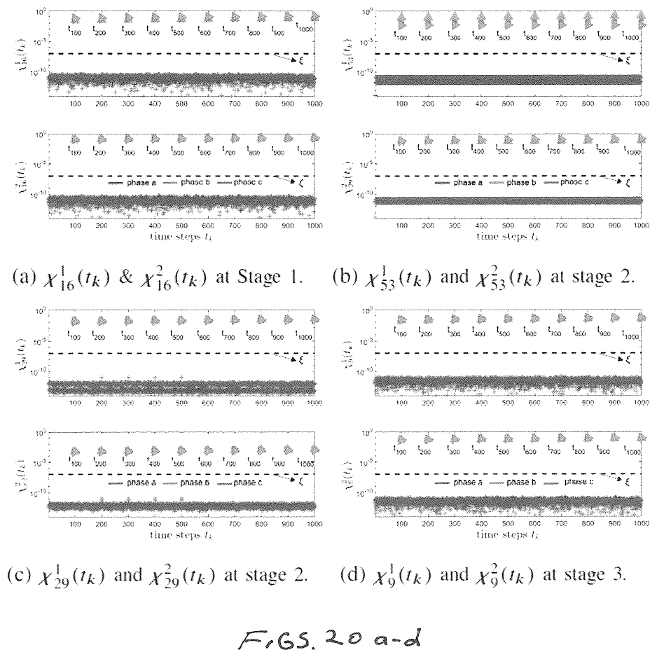

Results of both scenarios with all stages involved in the detection and localization process are illustrated in FIGS. 18 and 19. In stage 1, it is observable that for time instances tⱼ∈[t₁₀₀, t₂₀₀, . . . , t₁₀₀₀], the inference conditions at the overlapping Node 6, i.e.,

$${χ}_{6}^{1} ( {t}_{k} ) and {χ}_{6}^{2} ( {t}_{k} ) ,$$

do not hold. It violates the upper bound ξ with a substantial margin. This indicates that the measurements on the observable buses in G₁ or G₂, or both, have been compromised. Consequently, the inference at stage 1 successfully detects an attack.

Following initial detection, subsequent partitioning stages narrow the attack location. In stage 2, the plots from FIGS. 18 and 19 represent the inference conditions at overlapping nodes, [symbol] ₄ and [symbol] ₉, corresponding to the partitioning of subgraphs G₁ and G₂ respectively. Notably, observable buses [symbol] ₉ and [symbol] ₁₂ are uncompromised, as both inference conditions

$${χ}_{9}^{1} ( {t}_{k} ) and {χ}_{9}^{2} ( {t}_{k} )$$

remain within the specified numerical upper bound. The compromised measurements are localized within subgraph G₂, where measurements from observable buses [symbol] ₇ and [symbol] ₁₀ violate the inference at overlapping node [symbol] ₄, as shown by the plots of

$${χ}_{4}^{1} ( {t}_{k} ) and {χ}_{4}^{2} ( {t}_{k} ) .$$

To further refine the location within [symbol] ₇ and [symbol] ₁₀, one can leverage inferences from the previously identified uncompromised buses in conjunction with V₉ and [symbol] ₁₂ at any node.

These results highlight a substantial violation of inference conditions in the scenario involving voltage phasor manipulation compared to the first scenario, where only nodal injections are altered. This is attributed to the fact that the voltage phasor Vᵢ(tₖ) depends non-linearly on the voltage phasors and linearly on the nodal injections of all other buses.

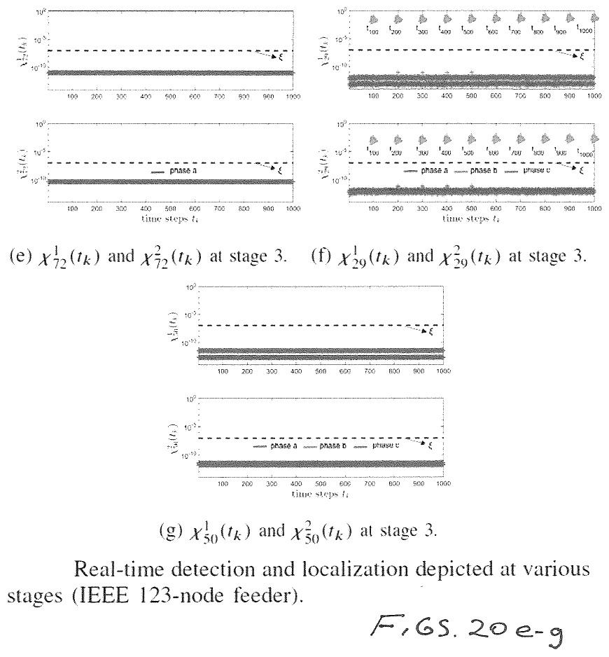

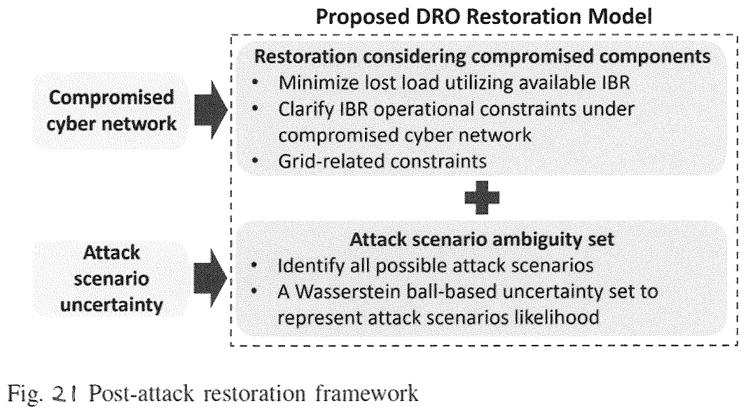

IEEE 123-node Distribution Feeder. This section examines a scenario for an IEEE 123-node distribution feeder. We consider random observable buses set [symbol] , comprising [symbol] ₃, [symbol] ₁₃, [symbol] ₂₂, [symbol] ₃₃, [symbol] ₄₂, [symbol] ₅₈, [symbol] ₆₈, and [symbol] ₇₇. This scenario assumes a similar configuration, where for tₖ∈[0, 1000s], the operating regime Sⱼ(tₖ) evolves from a baseline regime Sⱼ(t₀) based on a random loadability profile, as depicted in FIGS. 20a-g.

Furthermore, the upper bound for the inference conditions in (1) is set to 10⁻⁷. Initially, the partitioning strategy calculates sub-graphs, disjoint edges, and overlapping nodes for each stage in the detection and localization strategy. With eight observable buses, the scheme involves approximately three stages. In Stage 1, [symbol] ₃, [symbol] ₁₃, [symbol] ₆₈, [symbol] ₇₇ are placed in G₁, while [symbol] ₂₂, [symbol] ₃₃, [symbol] ₄₂, [symbol] ₅₈ are placed in G₂, with the overlapping node being [symbol] ₁₆. Stage 2 partitions G₁, placing [symbol] ₃, [symbol] ₁₃ in one subgraph and [symbol] ₆₈, [symbol] ₇₇ in the second, with [symbol] ₅₃ as the overlapping node. And G₂ partitioning in Stage 2 assigns [symbol] ₂₂, [symbol] ₃₃ to one and [symbol] ₆₈, [symbol] ₇₇ to the second, where [symbol] ₂₉ as the overlapping node. In Stage 3, the computation further partitions the subgraphs of G₁ and G₂ from Stage 2. It designates [symbol] ₉ as the overlapping node between [symbol] ₃ and [symbol] ₁₃, [symbol] ₇₂ as the node common among [symbol] ₆₈ and [symbol] ₇₇, [symbol] ₂₉ as the node for [symbol] ₂₂ and [symbol] ₃₃, and [symbol] ₅₀ as the interfacing node for [symbol] ₄₂ and [symbol] ₅₈.

Attack scenario involves manipulating voltage phasor measurements at Bus 13 and Bus 22. Specifically, for time instances tⱼ within [t₁₀₀, t₂₀₀, . . . , t₁₀₀₀], voltage measurements are gradually perturbed starting at 0.25% at t₁₀₀ and incrementally increasing by 0.225% every 100 seconds until reaching 2.5%.

Results for this scenario with all stages involved in the detection and location identification methodology are shown in FIG. 19. Notably, in Stage 1, the violation of inference conditions

$${χ}_{16}^{1} ( {t}_{k} ) and {χ}_{16}^{2} ( {t}_{k} )$$

for all tⱼ∈[t₁₀₀, t₂₀₀, . . . , t₁₀₀₀] triggers an attack detection due to surpassing the set threshold. This indicates potential compromise in either G₁, G₂, or both. In Stage 2, the violation of

$${χ}_{53}^{1} ( {t}_{k} ) and {χ}_{53}^{2} ( {t}_{k} ) for {G}_{1} and {χ}_{39}^{1} ( {t}_{k} ) and {χ}_{39}^{2} ( {t}_{k} )$$

for G₂ confirms that the compromised locations are within both clusters for all tⱼ. Finally, in Stage 3, the inference conditions confirm that compromised buses are localized within [symbol] ₃, [symbol] ₁₃, [symbol] ₂₂, [symbol] ₃₃, as the corresponding conditions for clusters associated with these observable buses surpass the threshold for all time instances tⱼ. The location among these buses can then be identified by employing inference from uncompromised buses [symbol] ₄₂, [symbol] ₅₈, [symbol] ₆₈, and [symbol] ₇₇.

A thorough analysis across all stages provides valuable insights into the framework's robust performance and the capability to address a variety of attack scenarios. It significantly contributes to fortifying the security and resilience of active distribution systems against cyber-physical threats.

The inverter-based resources (IBRs) have emerged as the new types of distributed energy resources (DERs) at the edge of distribution grids. These grid-edge IBRs are equipped with the capability of enhanced power quality, rapid response, and expanded functionalities, serving as the main interfaces for integrating renewable energy. Given their inherent low inertia and the uncertain nature of renewables, supplemental components such as smart sensors and controllers are necessary to facilitate the real-time monitoring and control of IBRS. While this evolving infrastructure is essential for ensuring the secure and reliable operation of distribution grids with IBRS, this expansion significantly broadens the attack surfaces of existing cyber networks. Moreover, non-utility owners of IBR might encounter challenges in establishing sufficient security policies and consequently elevating the risk of cyber threats.

Furthermore, the design of the cyber network allows accessibility to third parties such as IBR owners, manufacturers, and aggregators, posing safety concerns for unsecured network connections. Therefore, the increased exposure of the cyber networks of IBRs to potential attacks emerges as a significant security concern.

Common cyber-attacks, such as denial of services (DoS) or false data injection (FDI), targeting IBR cyber networks, might lead to severe consequences at the physical layer. These include branch overflow, posing risks of equipment damage, stability issues such as voltage/frequency violation, and even power outages. Strengthening distribution system resilience against cyber-attacks involves two main strategies. One way is to identify and strengthen the vulnerable components accordingly, thereby enhancing system resistance to cyber threats. The other way is to develop post-attack restoration methods, improving the system's ability to recover from cyber-attacks rapidly.

The majority of existing restoration algorithms mainly tackle the disruptions within the physical layer and usually assume the full functionality of the cyber layer, treating restoration as an optimization problem. However, the post-attack restoration necessitates accounting for the compromised cyber layer. Given the compromised components infiltrated by the malicious entity, if not identified and isolated successfully, attackers are able to launch subsequent attacks, continuously impacting the physical layer and potentially leading to a secondary outage. Therefore, the prevailing restoration algorithms from component failures, system malfunctions, or natural disasters are inadequate for handling post-attack restoration problems.

Furthermore, due to the intricate cyber-physical interdependence, it is challenging or usually impossible to pinpoint and identify the compromised components shortly after observing physical system failures, given very limited or implicit information of cyber-physical system status. Recent efforts have made some progress in detecting and locating potential attacks. For instance, a graph neural network may identify the presence and location of Fake Data Injection (FDI) attacks. Cluttering methods may determine the compromised phasor measurement units. A deep learning method may identify active attack locations. However, these approaches mainly utilize the data-based learning method, which requires massive data and powerful computational resources. Moreover, the training data are generally confined to specific devices or attack types. Consequently, when faced with incomplete attack information, these methods might struggle to identify the entry points of attacks within the cyber layer. This limitation could impede the ability of these algorithms to effectively identify and isolate the compromised components.

Motivated to address these challenges, the system 100 introduces a distributionally robust optimization (DRO) method to solve the post-attack load restoration problem. Instead of the deterministic identification of compromised components based on assumptions, this method develops an ambiguity set, reflecting the uncertainty of the probability of compromised components, leveraging the limited data from the cyber layer and the observations from the physical layer. Subsequently, based on this ambiguity set, the DRO algorithm is able to provide the optimal restoration strategy, ensuring the minimum expectation of lost load in the worst cases.

In the following sections, the framework is discussed and all formulas are renumbered starting with reference numeral one (1) to refer to this framework. The following formulas in this framework do not refer to previous formulas.

### Post-Attack Restoration Framework with IBRS

The grid-forming IBRs, such as the IBR field devices 110, are equipped with the ability to regulate their terminal voltages and system frequency, which enables them to independently establish a stable grid and function effectively in both grid-connected and islanded scenarios, significantly enhancing the adaptability of the system 100. Ensuring the secure operation of IBRs 110 heavily relies on a highly efficient communication network that enables real-time monitoring and control. However, the extensive presence of cyber components, such as sensors and routers, has notably broadened the attack surface of the supporting communication network. Moreover, non-utility owners, often lacking expertise in configuring secure policies, inadvertently introduce more vulnerabilities into these networks. Furthermore, due to the operational requirements of IBRs 110, which necessitate monitoring and support from manufacturers, aggregators, and maintainers, inadequate access policies may heighten the risk of insecure network connection. Hence, the escalating cyber threats within current IBR communication networks pose a significant risk to the secure operation of IBRs 110.

Some real-world attack cases emphasize the susceptibility of DERs to cyber threats. These cases reveal that current cyber layer vulnerabilities provide attackers with potential intrusion points, potentially enabling them to terminate essential communications, manipulate IBR control parameters, and issue false commands to IBRs 110. Given the low inertia of IBRs 110, such interruptions have the potential to induce severe system stability issues, trigger IBR trips and cause cascade failures, and consequently lead to load shedding and blackouts. Therefore, in anticipation of potential blackouts due to cyber-attacks, it is crucial to develop secure and reliable post-attack restoration strategies.

Existing restoration models are built upon the assumption of a fully functional cyber layer during the restoration process. Nevertheless, these models prove inadequate for post-attack restoration scenarios. The rapid recovery of cyber networks poses substantial challenges, wherein compromised components within the cyber layer can impede the execution of the restoration process, consequently giving rise to potential system instability and subsequent outages. In light of these considerations, there is a pressing need to enhance existing restoration frameworks to address the intricacies associated with post-cyber-attack recovery. To overcome this limitation, a deterministic post-attack restoration model that considers compromised cyber networks is first developed, as illustrated in FIG. 21. This model is designed to restore as much load as possible by utilizing available IBRs 110, and at the same time, isolating the identified compromised components. Besides the traditional grid-related constraints, this model incorporates operational constraints for IBRs 110, considering compromised components in the cyber layer. A detailed explanation of this deterministic model is provided below.

However, the timely identification of compromised components presents significant challenges with current detection algorithms, posing a feasibility issue for the deterministic model. To address this limitation, the DRO model is designed to handle the uncertainty inherent in attack scenarios, i.e., compromised components. This model integrates the deterministic model with an ambiguity set to address the attack scenario uncertainty. This ambiguity set is a Wasserstein ball-based distribution set, presenting the possibility level of each attack scenario, and ensuring a high confidence level that the actual probability distribution within this set. As a result, the DRO model can generate restoration plans that guarantee maximized load pickup across all scenarios. Further details on the development of the DRO model are discussed below.

DETERMINISTIC POST-ATTACK RESTORATION MODEL. The IBR operational guidelines considering compromised cyber networks are established first, followed by the formulation of the restoration model.

### IBR Operational Guidelines Under Cyber Attacks.

1) IBR control framework: Among various control algorithms designed for grid-forming IBRs, the load-sharing algorithm stands out for its cost-effectiveness and high reliability. This algorithm utilizes a distributed two-tier control framework. The secondary control gathers local and neighboring measurements, computes the deviation in their power ratios, and transmits it to the primary control, at the frequency of seconds. Operating with a faster cycle time within milliseconds, the primary control adjusts the terminal voltage and frequency to compensate for the power ratio deviations. As the system stabilizes in a steady state, the power ratio among each IBR unit becomes uniform, effectively achieving load sharing.

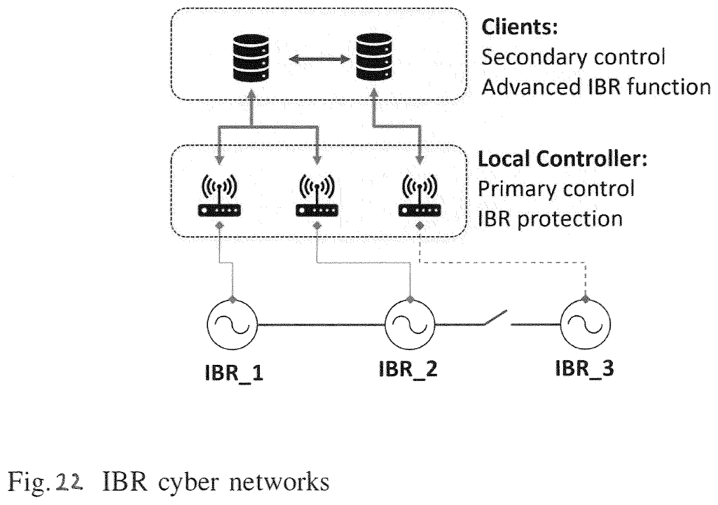

2) Cyber-attacks on IBR communication system. The IBR control algorithm necessitates a two-layer communication network, as shown in FIG. 22. The first layer encompasses IBR Clients as IBR manager clients 104, each of which communicates with one or several local controller clusters 108 and neighboring clients. These IBR clients handle the secondary control, as well as other advanced functions, such as emergency response. The second layer comprises local controllers 111, exclusively communicating with their associated clients. These controllers oversee the execution of primary control tasks and IBR protection, such as over- and under-voltage protection of the IBR devices 110.

The IBR Clients typically employ strict security policies, making it challenging for intruders to compromise. However, due to their ability to broadcast control commands to multiple IBR units and the support of various IBR functionalities, they often become the primary target for attackers. Once compromised, malfunctioning communication channels can cause system instability or operational violations due to the low inertia of IBRs. This disruption may lead to multiple IBR trips and even power outages. The attacks on local controllers 111 can yield similar consequences, although typically limited to the local areas. Due to their low cost and high impact, the increasing frequency of cyber-attacks on the IBR communication network could significantly disrupt IBR operations.

There are IBR operational guidelines considering a compromised cyber network. In FIG. 22 as an example, the communication channel between IBR 3 and its local controller may be compromised. To ensure the secure operation of IBRs, one option is to trip IBR 3 and terminate the compromised channel, thus the remaining IBRs can operate securely. However, it is worth noting that IBR is capable of operating in autonomous mode. In this mode, they utilize the default configuration to execute voltage and frequency control, serve local load within their capacity, and guarantee system state variables in normal range simultaneously. Yet, without communication with other IBRS, physical connection between two or more autonomous IBRS may cause unregulated power flow, leading to state variables exceeding the normal range, and potentially causing IBR trips. Hence, physical isolation between autonomous IBRs becomes necessary when they are operating in this mode. Therefore, an alternative option is to isolate IBR 3 in both physical and cyber layers and let it operate in autonomous mode, as shown in FIG. 22. Nevertheless, this strategy restricts the power flow within two sub-grids, potentially leading to a reduced load restoration.

The choice between these two options relies on comprehensive analysis. In this example, communication between IBR 2 and IBR 3 is disrupted, the first solution involves turning off IBR 3 to prevent potential disturbances. In the second solution, although IBR 3 is turned on, it is physically disconnected from IBR 2. In summary, to ensure the secure operation of IBRs under compromised cyber networks, it is essential to maintain consistency in their cyber and physical connectivity, regardless of their operation strategy.

There is a deterministic model formulation. Consider a distribution grid with [symbol] buses and [symbol] lines, alongside a set of [symbol] IBRs and [symbol] loads. The corresponding cyber network consists of [symbol] nodes and [symbol] links. In this work, the attackers are assumed to target cyber nodes exclusively. Let binary variable ξ indicate the cyber node status, which is predefined in the deterministic model. ξᵢ=0 refers to the i^{th} node is compromised; otherwise, it equals to 1. Incorporating with the IBR operational constraint, binary vector x, z is introduced to enable modification of IBR physical connections. Here, x^{Sw} denotes the states of line switches, while z^{IBR} refers to ON/OFF status of IBRs. S indicates the switchable lines. The binary vector y indicates the load status. The objective function of this model can be formulated as:

$${min}_{x , y , z} {\sum }_{l ∈ ℒ} ( 1 - {y}_{l} ) \cdot {P}_{l}^{Load} \qquad ( 1 )$$

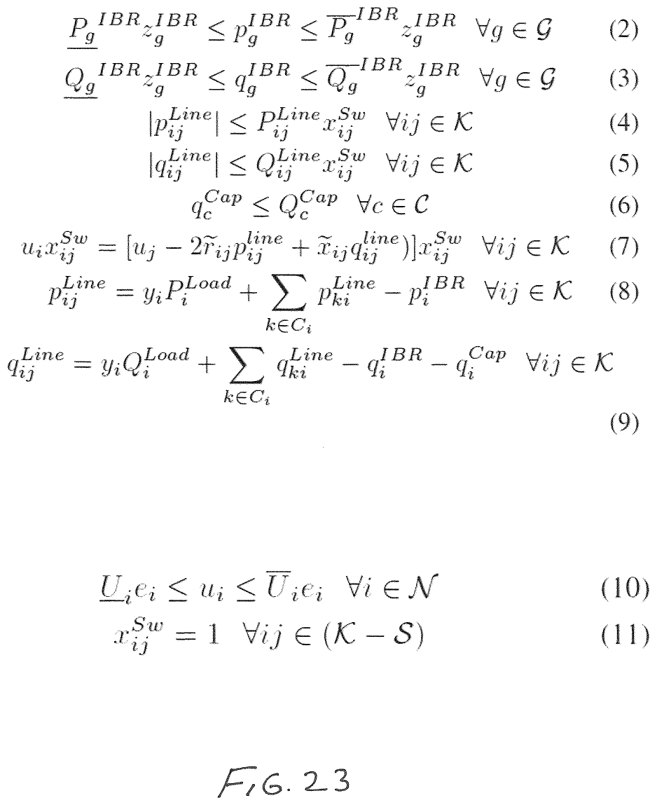

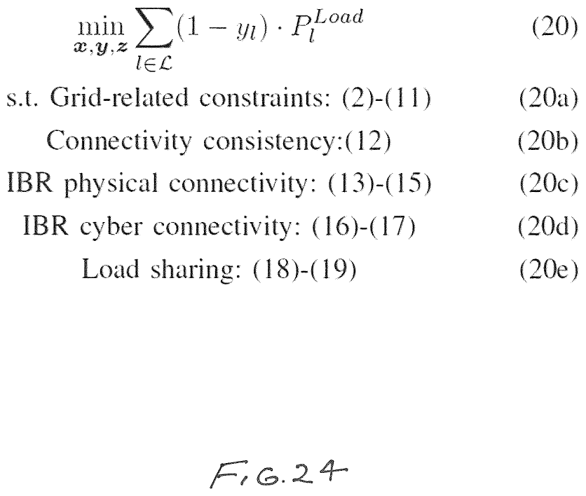

1) There are grid-related constraints. Let p, q refer to the real and reactive power, u indicate bus voltage square, and binary variable e refer to the energization status of buses. The grid related constraints can be formulated as shown in the equations of FIG. 23.

Constraints (2)-(6) represent the capacity limits of IBRs, line branches, and capacitor banks, respectively. (7) refers to voltage drop equation, (8) and (9) indicate the power flow equation, and Cᵢ indicates the children nodes of node i. (10) specifies the permissive voltage range. The determination of eᵢ and the load-sharing constraints are presented in the following discussion. (11) indicates the switchable lines.

2) There are IBR operational constraints considering compromised cyber nodes. The IBR connectivity is established among every pair of IBRs. Let G^{pair} denote all possible pairs, the binary variable Con^{p} indicates the IBR physical connectivity and Conc denotes the IBR cyber connectivity. Based on the previous discussion, the IBR cyber and physical connectivity should be consistent to ensure secure operation. This constraint can be formulated as follows:

$$\begin{matrix}{Con}_{ij}^{p} = {Con}_{ij}^{c} & ∀ ij ∈ {𝒢}^{pair}\end{matrix} \qquad ( 12 )$$

The IBR physical connectivity is determined as follows: assuming ρ^{ij} refers to the set of all possible physical paths from IBRᵢ to IBRⱼ, which can be derived by the depth-first search algorithm. Let binary variable Sₘ^{p,ij} indicate the status of the m^{th} path in ρ^{ij}. Therefore, Sₘ^{p,ij} is active only when all on-path switches are closed, expressed as follows:

$${S}_{m}^{p , ij} = {\prod }_{kq ∈ {p}_{m}^{ij}} {x}_{kq}^{Sw} \qquad ( 13 )$$

where kq denotes the line from bus k to bus q.

The physical connectivity of IBRs is determined by the path status, as well as IBRs ON/OFF status. It is active when both IBRs are online, and at least one path between them is active, which can be expressed as follows:

$${Con}_{ij}^{p} = ( 1 - {\prod }_{m} ( 1 - {S}_{m}^{p , ij} ) ) \cdot {z}_{i}^{IBR} \cdot {z}_{j}^{IBR} \qquad ( 14 )$$

Similarly, eᵢ=1 if the i^{th} bus is connected to at least one IBR in the ON state. It is determined using the following equation:

$${e}_{i} = 1 - {\prod }_{k ∈ 𝒢} [ 1 - ( 1 - {\prod }_{m} ( 1 - {S}_{m}^{p , ki} ) ) \cdot {z}_{k}^{IBR} ] \qquad ( 15 )$$

The cyber connectivity is derived in a similar way. Assuming the cyber node directly connected to IBRᵢ and IBRⱼ at node k and node q respectively, the set of paths in between is σ^{kq}, then the p^{th} path status Sₚ^{c,kq} is positive when all on-path cyber nodes (including starting and end nodes) is in normal status, which can be formulated as:

$${S}_{p}^{c , kq} = {\prod }_{v ∈ {σ}_{m}^{kq}} {ξ}_{m} \qquad ( 16 )$$

Therefore, the cyber connection between IBRᵢ and IBRⱼ is active if there exists at least one active path in σ^{kq}, expressed as follows:

$$\begin{matrix}{Con}_{ij}^{c} = ( 1 - {\prod }_{p} ( 1 - {S}_{p}^{c , kq} ) ) & ∀ ij ∈ {𝒢}^{pair}\end{matrix} \qquad ( 17 )$$

In addition, the load-sharing algorithm ensures that the output power ratio among interconnected IBRs remains identical in the steady state, formulated as follows:

$$\begin{matrix}\frac{{p}_{i}^{IBR}}{{\overline{P}}_{i}^{IBR}} {Con}_{ij}^{p} = \frac{{p}_{j}^{IBR}}{{\overline{P}}_{j}^{IBR}} {Con}_{ij}^{p} & ∀ ij ∈ {𝒢}^{pair}\end{matrix} \qquad ( 18 )$$

$$\begin{matrix}\frac{{q}_{i}^{IBR}}{{\overline{Q}}_{i}^{IBR}} {Con}_{ij}^{p} = \frac{{q}_{j}^{IBR}}{{\overline{Q}}_{j}^{IBR}} {Con}_{ij}^{p} & ∀ ij ∈ {𝒢}^{pair}\end{matrix} \qquad ( 19 )$$

In summary, the deterministic model is formulated as shown in FIG. 24 with reference to the formulas as referenced.

PROPOSED DRO MODEL. In reality, it is significantly challenging to fully identify the compromised nodes in real time, which notably reduces the practicality of the proposed deterministic model (20). To tackle this issue, the DRO model has been established. Compared to stochastic optimization, the proposed DRO model does not require complete knowledge of the attack probability distribution, which is challenging to obtain due to limited historical data. While robust optimization can address this issue without necessitating the complete distribution information, it may lead to overly conservative solutions. In contrast, the DRO model utilizes partial distribution information, providing effective yet robust restoration solutions. This section will first introduce the establishment of the ambiguity set, and then present the DRO model formulation.

A. Ambiguity Set. Given the condition of observed physical outages denoted as γ, the probability of scenario ξ can be represented as P(ξ|γ). While one cannot directly obtain the information of this probability, it can be determined through the Bayesian inference as follows:

$$P ( ξ \vert γ ) = \frac{P ( γ \vert ξ ) P ( ξ )}{{\sum }_{Ξ} P ( γ \vert {ξ}^{i} ) P ( {ξ}^{i} )} \qquad ( 21 )$$

where Ξ represents the supporting space of ξ. P(ξ|γ) can be determined by the following steps.

Determination of P(γ|ξ):P(γ|ξ) indicates the probability of γ given attack scenario ξ. This probability represents the problem faced by attackers in determining their targets, i.e., which IBR to trip, which can be addressed using a Quantal Response model. This model suggests that owing to incomplete information or subjective preferences, attackers may not necessarily choose the node with the highest reward U. Instead, they might target all IBRs. To capture this scenario, a non-negative parameter μ is introduced to assess their rationality level. A higher μ signifies a greater likelihood of selecting targets with larger U. Specifically, the probability of each node being chosen is determined by the following:

$$P ( γ \vert ξ ) = \frac{exp ( {μ}_{ξ} {U}_{γ} )}{{\sum }_{{Γ}^{ξ}} exp ( {μ}_{ξ} {U}_{{γ}^{′}} )} \qquad ( 22 )$$

U is defined as the capacity of tripped IBRS, expressed as follows:

U_{γ}=(1−γ)^{T}Cap^{IBR} (23)

Let Γ denotes all possible scenarios of IBR tripping. Then Γ^{ξ} is a sub-set of ξ, indicating all IBR tripping scenarios under ξ, which is determined by analyzing the cyber-physical interdependency model.

The cyber-physical interdependency can be modeled as a graph-based mapping function M(t) to demonstrate the data exchange patterns between the control and physical system layers. M(t) is derived from the cyber node functionality matrix denoted as F(t), the data packets transition path matrix P(t), and the data packets starting node incidence matrix S. The mapping function of i^{th} cyber node Mⁱ is determined by the following equation:

Mⁱ=(diag(Pⁱ⊙F))^{T}·Sⁱ (24)

Accordingly, the cyber sensitivity matrix, indicating which IBR can be tripped by each node, is defined as:

$$Sen = [ \frac{{dM}^{1}}{d {λ}^{1}} … \frac{{dM}^{ℳ}}{d {λ}^{ℳ}} ] \qquad ( 25 )$$

where λ refers to the input data of each node. In this model, it refers to the IBR control command. Replacing all non-zero elements in Sen as 1, and denotes the new matrix as Sen′. Thus, all possible tripped IBRs under ξ, denoting as \hat{γ}^{ξ} is determined by following equation:

\hat{γ}^{ξ}=Sen′(1−ξ) (26)

Thus, Γ^{ξ} can be determined accordingly.

2) Determination of P(ξ): Recently, in response to the escalating cyber threats to power systems, the deployment of honeypot systems as intrusion detection techniques in power systems supporting communication networks has become more popular. These systems meticulously monitor and log intrusion attempts, regardless of whether they would lead to physical impacts or not. However, given the limited implementation, the data collected by the honeypot system might not be sufficient to establish a convincing attack probability distribution. Nevertheless, it can contribute to the development of a Wasserstein ball-based probability distribution set, which presents the desirable out-of-sample performance. This set ensures that the true P(ξ) falls within the distribution set with a considerable confidence level, which is suitable for approximating P(ξ).

Assuming the honeypot system has collected N historical data: \hat{ξ}¹, \hat{ξ}², . . . \hat{ξ}^{N}, then the empirical distribution of ξ is formulated as:

$${P}_{0} ( ξ ) = \frac{1}{N} {\sum }_{i = 1}^{N} {δ}_{{\hat{ξ}}^{1}} ( ξ ) \qquad ( 27 )$$

where δξ·i is defined by following equation:

$${δ}_{{\hat{ξ}}^{1}} = \{ \begin{matrix}1 , & {\hat{ξ}}^{1} = ξ \\ 0 , & otherwise\end{matrix} \qquad ( 28 )$$

The supporting space E can be approximated as the sampling space. For a given confidence level β, there is always a Wasserstein ball centered with P₀(ξ) satisfying:

P(D_{W}(P(ξ),P₀(ξ))≤v)≥β (29)
where v indicates the Wasserstein ball radius and can be derived by the following equation:

$$v = D \sqrt{\frac{- 2 log ( 1 - β )}{N}} \qquad ( 30 )$$

where D denotes the diameter of ξ supporting space. Given historical data and a predefined confidence level, v is fixed. D_{W}(P(ξ), P₀(ξ)) in (29) refers to the Wasserstein distance, which is defined as follows:

$${D}_{w} ( P ( ξ ) , {P}_{0} ( ξ ) ) = \text{?} ‖ ξ - {ξ}^{′} ‖ p ( ξ , {ξ}^{′} ) \qquad ( 31 )$$

$$\text{?} \text{indicates text missing or illegible when filed}$$

where p(ξ, ξ′) is the combined probability of (ξ, ξ′), with the marginal probability of P(ξ) and P₀(ξ), respectively. Then, (31) can be reformulated as follows [22]:

$$\text{?} ‖ ξ - {ξ}^{′} ‖ p ( ξ , {ξ}^{′} ) \leq v \qquad ( 32 )$$

$$\text{?} p ( ξ , {ξ}^{′} ) = P ( ξ ) \qquad ( 32 a )$$

$$\text{?} p ( ξ , {ξ}^{′} ) = {P}_{0} ( {ξ}^{′} ) \qquad ( 32 b )$$

$$\text{?} \text{indicates text missing or illegible when filed}$$

Thus, the ambiguity set of P(ξ|γ), denoted as P, can be summarized as:

P={P(ξ|γ)|(21)(22)(32)} (33)

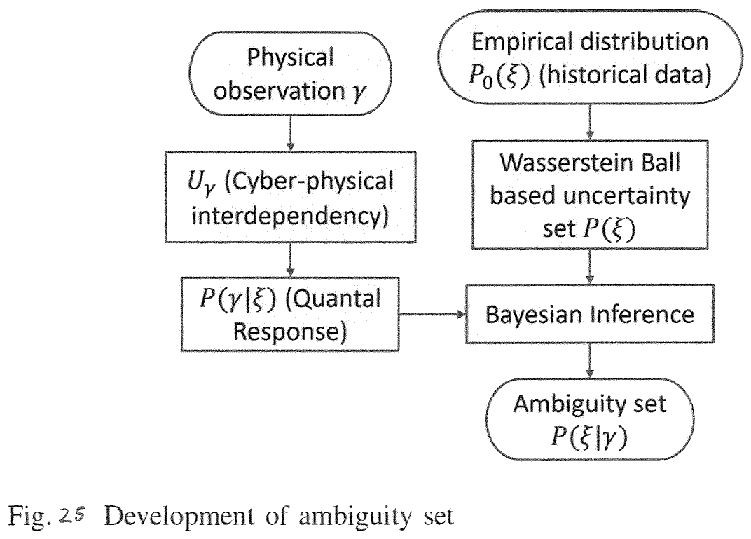

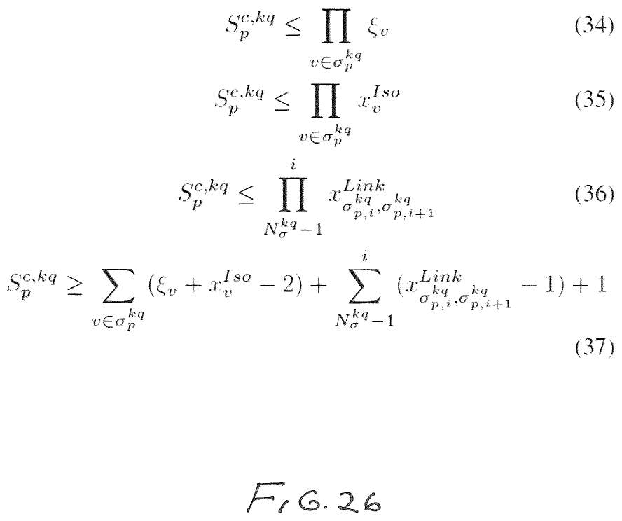

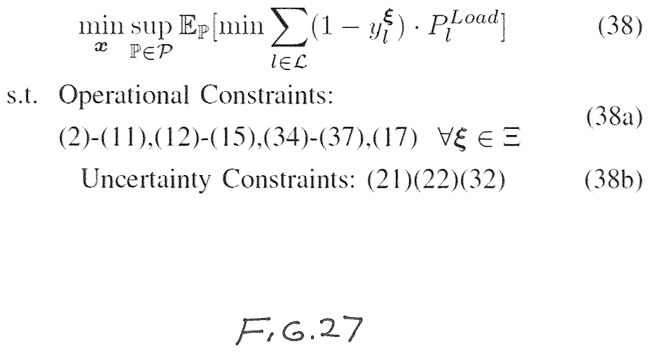

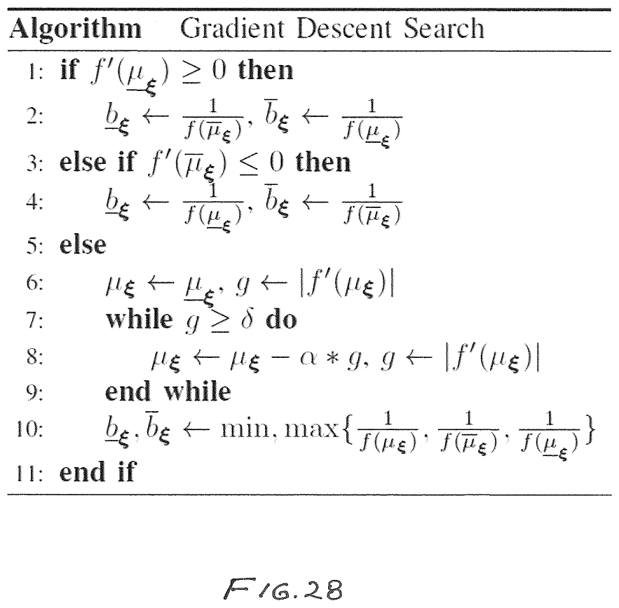

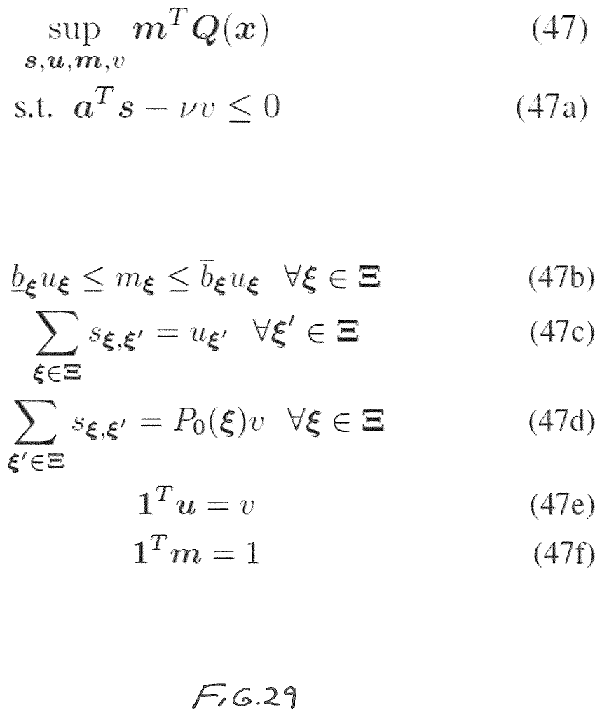

In summary, the development of the ambiguity set are presented in FIG. 25. First, the model utilizes our previously established cyber-physical interdependency model to determine attack reward U given any γ. Then the Quantal Response model is used to determine the marginal likelihood P(γ|ξ). Subsequently, an uncertainty set is constructed to represent the prior probability P(ξ). This set is a Wasserstein ball-based set centered with empirical distribution P₀(ξ). Finally, according to Bayesian inference, the ambiguity set representing the probability level of all possible scenarios P(ξ|γ) can be derived.

There is a DRO formulation. The DRO model aims to generate a sub-grid plan to minimize the expected lost load across all possible scenarios in the worst-case situations. Consequently, ξ becomes a variable in this case, with the ambiguity set of (33). The decision variable x pertains to the sub-grid plan. Specifically, x^{Iso} denotes whether the cyber node requires isolation, particularly if its likelihood of being compromised is relatively high. x^{Link} refers to the decision to terminate the communication channel within the cyber network to facilitate its sub-grid. Meanwhile, x^{Sw} still denotes the line relay status, serving the purpose of the physical distribution system sub-grid.

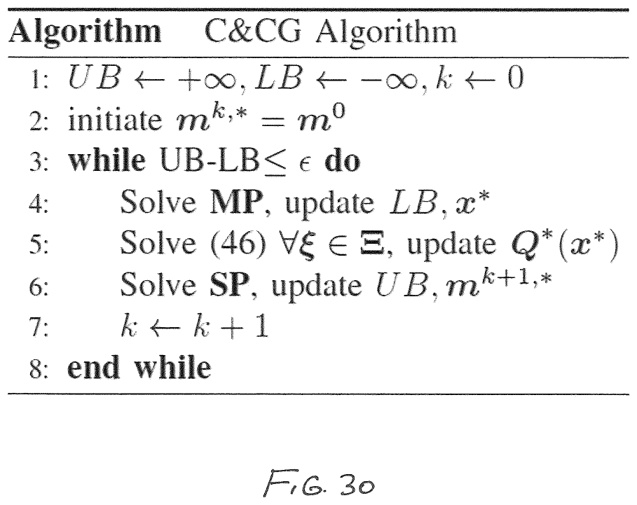

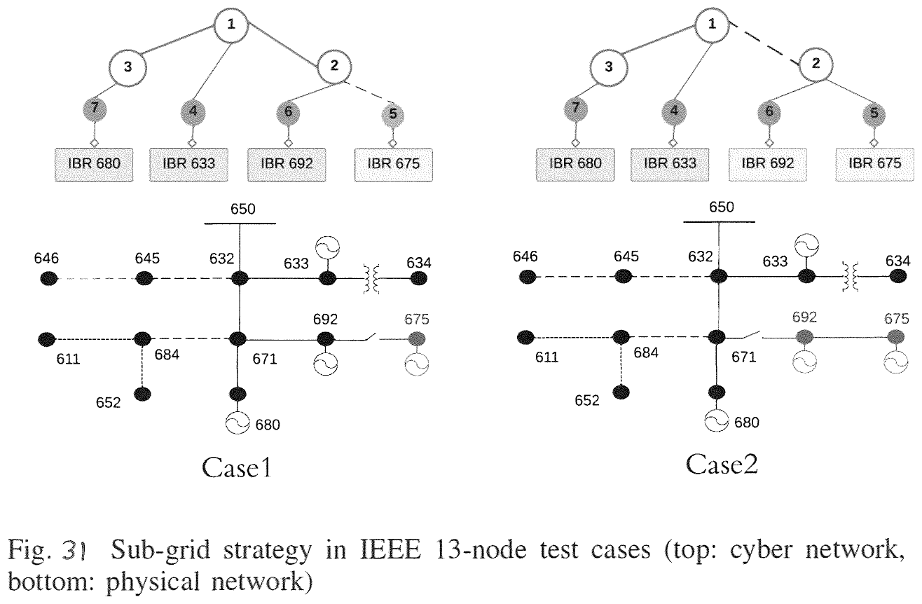

In the DRO model, the operational constraints remain identical to the deterministic model, except for cyber connectivity, which is determined as follows. Assuming the set of paths between node k and node q is still σ^{kq}, then the p^{th} path status is active only when there are no isolated nodes, compromised nodes, and terminated links on the path, which can be expressed as shown in the formulas of FIG. 26. In summary, the proposed DRO model can be formulated as shown in the formulas and references to formulas shown in FIG. 27.

REFORMULATION OF DRO MODEL. The non-convexity of (38) presents challenges for the off the shelf solvers. In this section, the DRO model is reformulated step by step and transformed into a tractable problem.

A. Reformulation of Quantal Response Constraint. Rewrite (22) as follows:

$$P ( γ \vert ξ ) = \frac{1}{{\sum }_{{Γ}^{ξ}} exp ( {μ}_{ξ} ( {U}_{{γ}^{j}} - {U}_{γ} ) )} \qquad ( 39 )$$

Let f(μ_{ξ})=Σ_{Γ}_{^{ξ}} exp(μξ(Uγj−Uγ), then the second order derivative of f(μ_{ξ}) is expressed as follows:

$$\frac{{d}^{2} f}{d {μ}_{ξ}^{2}} = {\sum }_{{Γ}^{ξ}} {( {U}_{{γ}^{j}} - {U}_{γ} )}^{2} exp ( {μ}_{ξ} ( {U}_{{γ}^{j}} - {U}_{γ} ) ) \qquad ( 40 )$$

As

$$\frac{{d}^{2} f}{d {μ}_{ξ}^{2}}$$

is positive definite, f(μ_{ξ}) is convex. Giving μ_{ξ} within the non-negative range [μξ, μ_{ξ}], f(μ_{ξ}) is bounded and positive. Thus, let b_{ξ}=P(γ|ξ), then b_{ξ} is solely contingent on μ_{ξ}, and

$${\underline{b}}_{ξ} \leq {b}_{ξ} \leq {\overline{b}}_{ξ} \qquad ( 41 )$$

$${\underline{b}}_{ξ} = \frac{1}{max f ( {u}_{ξ} )} , {\overline{b}}_{ξ} = \frac{1}{min f ( {u}_{ξ} )}$$

The determination of [b_{ξ}, b̅_{ξ}] can be referred to the algorithm shown in FIG. 28 as a gradient descent search. As μ_{ξ} is independent of other variables, it can be eliminated in this model, and constraint (22) is equivalent to (41).

In the algorithm shown in FIG. 28, α refers to the user-defined step size. A smaller α tends to improve the convergence of this algorithm but increases the execution time. δ indicates a minimal value, forcing the gradient to approach 0.

B. Transformation of Inner Problem. Based on (41), (21) can be reformulated as:

$$P ( ξ \vert γ ) \text{?} {b}_{ξ} , P ( {ξ}^{4} ) = {b}_{ξ} P ( ξ ) \qquad ( 42 )$$

$$\text{?} \text{indicates text missing or illegible when filed}$$

Next, let new variable k_{ξ}=b_{ξ}P(ξ), then (42) and (41) can be rewritten as follows:

$$P ( ξ \vert γ ) = \frac{{k}_{ξ}}{\text{?} {{k}_{ξ}}^{i}} \qquad ( 43 )$$

$${\underline{b}}_{ξ} P ( ξ ) \leq {k}_{ξ} \leq {\overline{b}}_{ξ} P ( ξ ) \qquad ( 44 )$$

$$\text{?} \text{indicates text missing or illegible when filed}$$

Insert (43) into objective function, the proposed DRO model (38) can be reformulated as follows:

$${min}_{x} {sup}_{P ∈ 𝒫} \frac{\sum \text{?} {k}_{ξ} {Q}_{ξ} ( x )}{\sum \text{?} {k}_{ξ}} \qquad ( 45 )$$

$$\text{?} \text{indicates text missing or illegible when filed}$$

where Q_{ξ}(x) is a MILP problem and defined as follows:

$${Q}_{ξ} ( x ) = {min}_{{y}^{ξ} , {z}^{ξ}} \{ {\sum }_{l ∈ C} ( 1 - {y}_{l}^{ξ} ) \cdot {P}_{ℓ}^{Lead} : ( 2 ) - ( 11 ) ( 12 ) - ( 15 ) ( 17 ) ( 34 ) - ( 37 ) \} \qquad ( 46 )$$

(45) is an optimization problem with linear fraction objective function and linear constraints, constituting a quasi-convex problem, and can be transformed into a convex form:

$${Let {s}_{ξ , {ξ}^{′}} = \frac{p ( ξ , {ξ}^{′} )}{\sum {k}_{ξ}} ,}_{\text{?}} {{u}_{ξ} = \frac{P ( ξ )}{\sum {k}_{ξ}} ,}_{\text{?}} {{m}_{ξ} = \frac{{k}_{ξ}}{\sum {k}_{ξ}} ,}_{\text{?}} {υ = \frac{1}{\sum {k}_{ξ}}}_{\text{?}} \qquad ( 47 )$$

$$\text{?} \text{indicates text missing or illegible when filed}$$

Then the inner sup problem of (45) can be rewritten as the formulations shown in FIG. 29 where a^{ξ,ξ}′=∥ξ−ξ′∥. Thus, the proposed DRO model becomes a traceable optimization problem.

C. C&CG-based Solution Algorithm. The proposed DRO problem is a tri-level optimization problem, which can be solved by the C&CG algorithm shown in FIG. 30. This algorithm decomposes the original problem into two subproblems. The master problem is formulated as follows:

$$MP : {min}_{x} η \qquad ( 48 )$$

$$s . t . η \geq \text{?} m \text{?} [ {( 1 - {y}^{ξ , t} )}^{T} {P}_{Load} ] ∀ t \leq k \qquad ( 48 a )$$

$$( 2 ) - ( 11 ) ( 12 ) - ( 15 ) ( 34 ) - ( 37 ) ( 17 ) ∀ ξ ∈ \text{?} \qquad ( 48 b )$$

$$\text{?} \text{indicates text missing or illegible when filed}$$

The sub-problem is a bi-level problem, which can be referred to (47), where the second level problem Q(x) is defined by (46). The implementation of the C&CG algorithm for solving the reformulated DRO problem is outlined in the algorithm of FIG. 30. The overall iteration process can be described as follows: Upon initializing m^{k,*}, the master problem transforms into a single-level MILP problem. The lower bound LB is updated as its objective value, and the optimal sub-grid plan x* is obtained. Subsequently, (46) is solved for any given x* to derive Q(x) under each attack scenario ξ. The sub-problem (47) then becomes a linear problem. The upper bound UB is updated with the objective value of (47), and m^{k+1,*} is determined for the next iteration. This iteration loop continues until LB and UB are sufficiently close.

The comprehensive process of DRO reformulation and solution algorithm can be summarized as follows: first, reformulate (22) into an equivalent linear box constraint (41). Subsequently, the inner problem can be transformed into a linear fraction form. This can be further converted into a convex problem through variable substitution. As a result, this DRO problem is transformed into a tractable tri-level optimization problem that can be resolved using the C&CG algorithm.

### SIMULATION RESULTS. A. IEEE 13-Node Test Cases.

1) Test system: The standard test system is modified to include IBRs at Nodes 680, 633, 692, and 675, with different capacities of 700 kW, 1000 kW, 600 kW, and 1000 kW, respectively. The circuit breakers are located at Lines 670671, 671692, and 692675. The corresponding cyber network is shown in FIG. 31. The cyber nodes can be divided into two tiers: IBR clients and local controllers. In this test system, Nodes 1, 2, 3 are designed as clients, while the remaining nodes serve as local controllers.

Let us assume IBR at Node 675 is reported to be tripped. The historical data identifies 7 distinct attack scenarios, each targeting one unique cyber node. The confidence level β is set to 95%, data size N=1000, and there is a range of regional index. Two cases have been developed and tested, each with different empirical distributions. Case 1 depicts a scenario where local controllers have a higher probability of being attacked. This may be due to insufficient security configuration in the local controllers. Case 2 portrays a scenario where IBR clients are more susceptible to attacks, likely due to attackers prioritizing client nodes that could potentially cause more significant impacts on the physical layer.

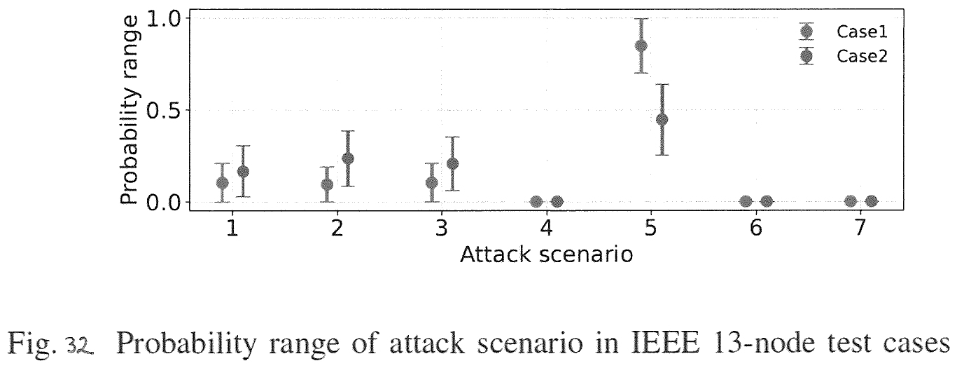

2) There is an attack probability. The graph of FIG. 32 indicates the probability range of each attack scenario. The scenario index corresponds to the compromised node. It can be observed that Scenarios 4, 6, and 7 exhibit a probability of 0, as Nodes 4, 6, and 7 function as local controllers without the authorization to manage other IBRs. Consequently, they are unable to trigger IBR 675 to trip. Conversely, Nodes 1, 2, and 3 operate as client nodes, possessing the necessary authorization to initiate trip commands for IBR 675. Meanwhile, Node 5 acts as the local controller of IBR 675, empowered to issue a trip command when specific protection mechanisms are activated.

In Case 1, the most probable scenario is the compromise of local controller at Node 5, with a probability range between 0.7 and 1. In Case 2, there is a higher probability of the client node being attacked, ranging approximately from 0.1 to 0.3. Besides, the probability range for Node 5 experiences a noticeable decrease compared to Case 1.

There is a restoration result. In Case 1, due to the dominant probability of an attack on Node 5, the DRO model proposes a strategy to isolate Node 5 directly within the cyber layer. Accordingly, Node 675 is disconnected from the main grid in the physical layer. The distribution grid is therefore divided into two sub-grids. During restoration, IBR 675 operates in autonomous mode, eliminating the impact from the compromised local controller. In Case 2, the compromised nodes within the client nodes hold a higher likelihood, potentially impacting more IBRs. To respond to this risk, the proposed DRO method provides a strategy to divide the distribution grid into two sub-grids, of which one with IBRs 692 and 675 and the other with IBRs 633 and 680, restricting the potential impact of compromised client nodes within smaller regions, thereby reducing the overall lost load.

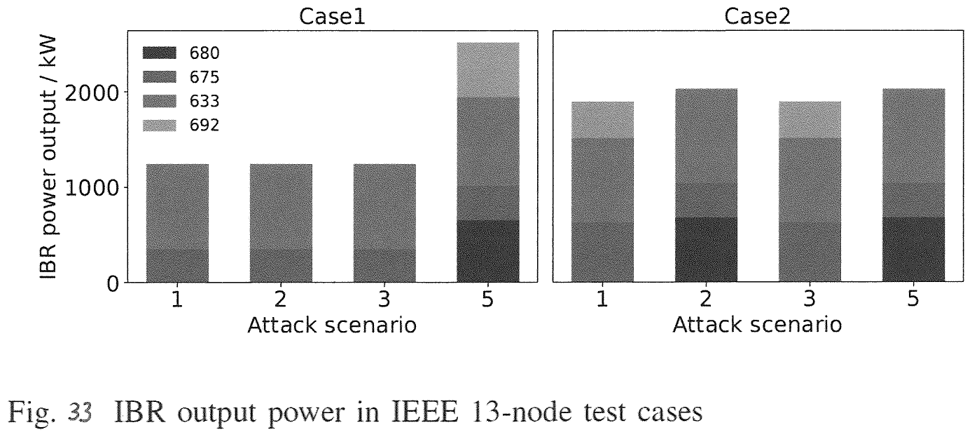

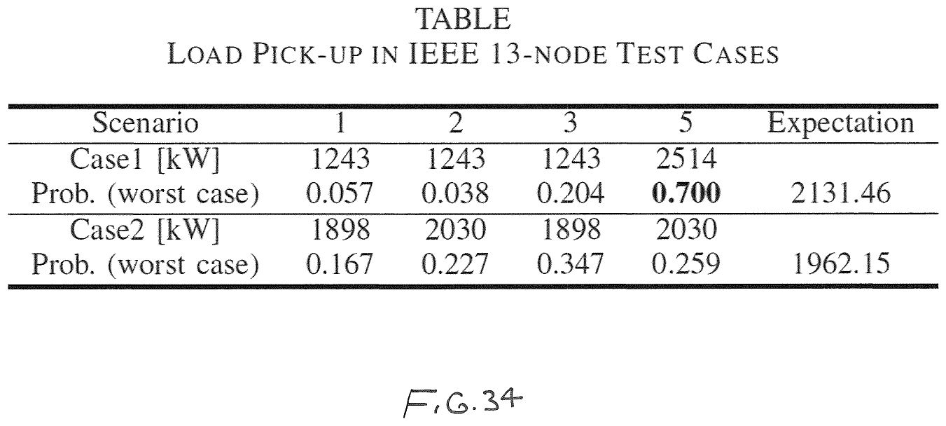

The table in FIG. 33 illustrates the IBR output across all scenarios. In Case 1, the compromise of Nodes 1, 2, or 3, as per the sub-grid plan, impacts the sub-grid composed of IBRs 680, 633, and 692. To ensure optimal operations amid a compromised communication network, the most secure strategy is to select an IBR with the largest capacity for operation while keeping the others offline. Simultaneously, isolating IBR 675 from the remaining IBRs enables its autonomous operation in every scenario. In scenario 5, the accurate isolation of the compromised node allows the sub-grid comprising IBRs 680, 633, and 692 to securely operate in a load-sharing mode, resulting in increased load pickup. In Case 2, in Scenarios 1 and 3, IBRs 692 and 675 establish a secure connection, allowing them to operate efficiently in a load-sharing mode. Conversely, only one unit between IBRs 680 and 633 can remain online. In Scenario 2 and 5, the situation reverses. In summary, this sub-grid plan accommodates the operation of 3 IBRs and ensures balanced load pick-up in each scenario. FIG. 34 includes the table showing the load pick-up in IEEE 13-node test cases.

For load restoration, the medium-level loads are typically recoverable across all cases and scenarios. However, the restoration of larger loads depends on the sub-grid capability. Essentially, the DRO model provides adaptive sub-grid plans customized to specific probability profiles, ensuring optimal load recovery across all potential scenarios.

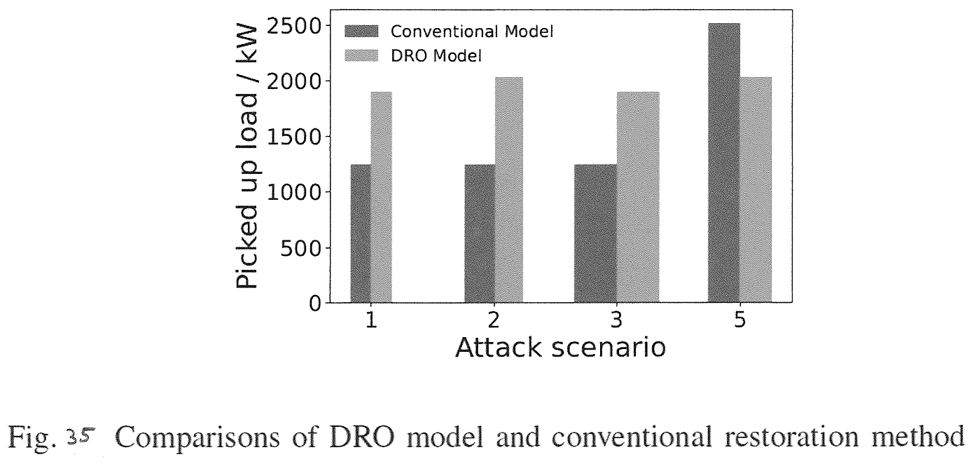

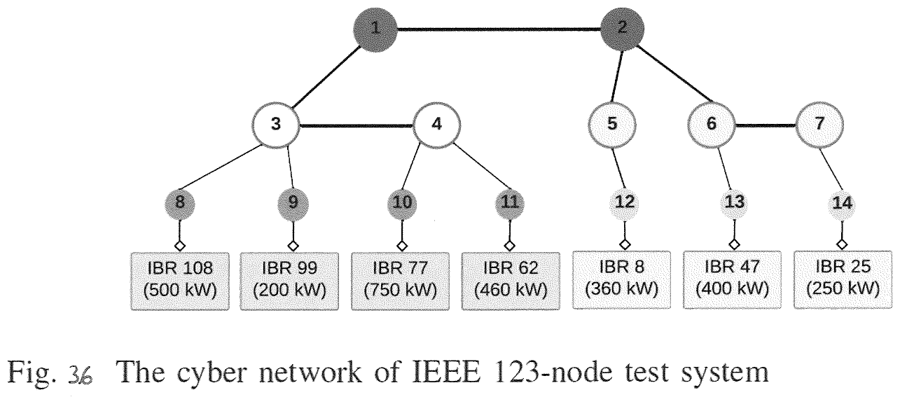

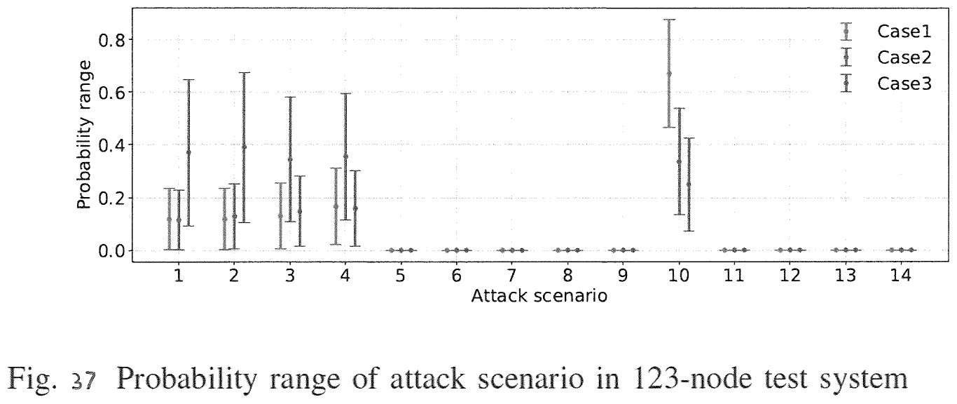

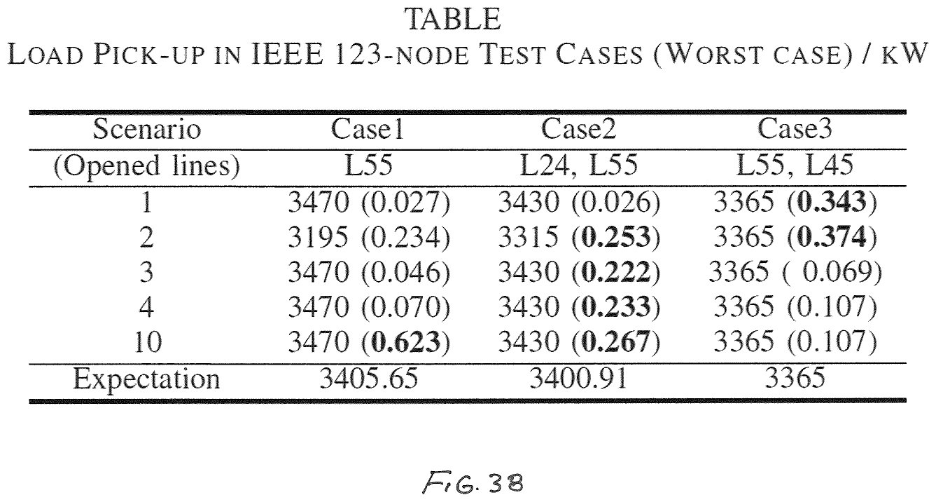

4) There is a comparison to conventional restoration. To demonstrate the performance of the proposed model, this section compares the DRO method with the conventional restoration approach. Following the reported IBR 675 incident, the conventional restoration algorithm ignores cyber-physical interdependency and directly isolates IBR 675, allowing it to operate autonomously, which is the same restoration strategy offered by the proposed DRO in Case 1. FIG. 35 is a chart that illustrates the load restoration derived by the proposed DRO and the conventional model in the worst case.

In FIG. 35, the x-axis represents attack scenarios. The bar heights depict the load pick-up in each scenario, while the bar widths denote the probability of each scenario. In Scenarios 1, 2 and 3, the conventional method displays less load pickup. This is because within the sub-grid of IBRs 680, 633, and 692, only one IBR can securely operate in autonomous mode, thereby limiting the total available IBR capacity under this plan. Conversely, the DRO model offers an alternative sub-grid plan, as previously discussed, enabling more IBRs to operate securely and consequently pick up more load in these scenarios. In Scenario 5, the conventional restoration outperforms by accurately identifying the compromised node. The DRO's load pick-up is slightly less due to the offline status of IBR 692, prioritizing the secure operation of IBR 675. Despite this, considering its relatively low probability, the DRO method demonstrates superior overall performance.

### B. IEEE 123-Node Test Cases.

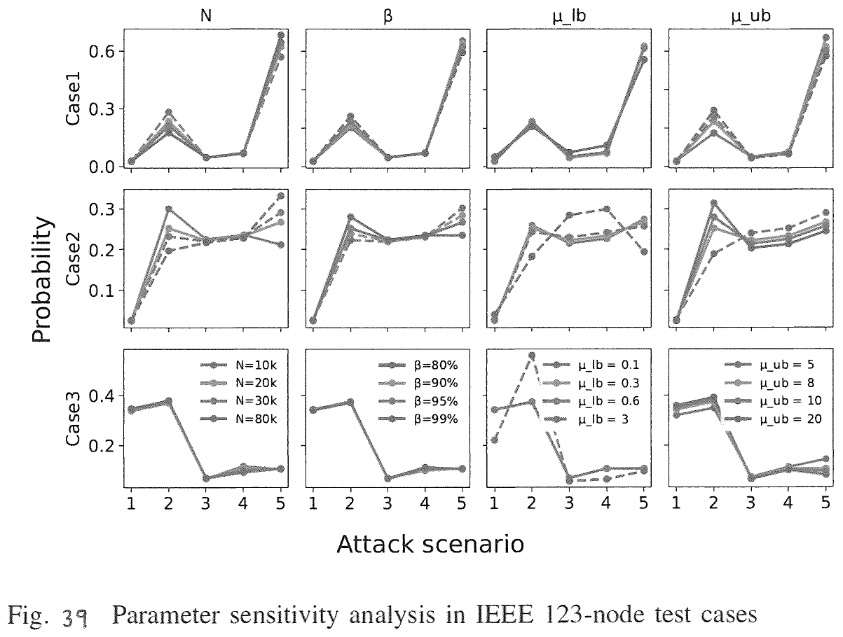

1) Test system: The standard test system is modified to include 7 IBRs and 11 switchable lines (Line L24, L13, L55, L61, L117, L68, L76, L105, L45, L96, L10). The IBR location, capacity, and the cyber network topology can be shown in the topology of FIG. 35. This network is delineated into two clusters, represented by the left and right sides in FIG. 36. The cyber system includes two tiers: clients and local controllers, same as the previous test system. However, the client nodes encompass two types: regular nodes (3, 4, 5, 6, 7) and cluster leads (1, 2). Regular nodes have control capabilities confined to their respective in cluster IBRs. In contrast, cluster leads possess the ability to manage in-cluster IBRs and coordinate with IBRs outside their cluster. Within this system, historical data reveals the existence of 14 distinct scenarios, each involving an attack on a specific node.

Considering the reported trip of IBR 77, three cases are designed. Case 1 assumes a scenario of random attack behavior. The local controllers, being generally more vulnerable, present a higher probability of being targeted in this case. Case 2 assumes attackers with a more regional focus. Given that regular clients are relatively easier to compromise and the impact surface is substantial, they attract the largest number of attackers. In Case 3, the attackers adopt a more radical approach, leaning towards targeting cluster leads as they possess the ability to impact a greater number of IBRs.

2) There is a probability of attack scenario. The graph of FIG. 37 illustrates the probability ranges for attack scenarios in each case. As the regular client nodes possess control over in-cluster IBRs, Nodes 5, 6, and 7 lack the capability to trip IBR 77, resulting in a zero probability of attack for these nodes. Furthermore, aside from local controller 10, other local controllers (8, 9, 11, 12, 13, 14) also lack the ability to trip IBR 77. In Case 1, the local controller at Node 10 exhibits the highest probability of attack, ranging between 0.47 and 0.88. Each of Nodes 1, 2, 3, and 4 presents a relatively even probability, approximately ranging from 0 to 0.2. In Case 2, regular clients at Nodes 3 and 4 exhibit considerable probabilities, along with local controller at Node 10, ranging from approximately 0.1 to 0.6. The probability of attack for cluster leads 1 and 2 remains relatively low, peaking at less than 0.3. In Case 3, the cluster leads display the highest probability of being targeted, ranging from 0.1 to 0.7. Conversely, the probability of local controller attack is notably lower in this case, approximately ranging from 0.1 to 0.4. Nodes 3 and 4 depict the lowest probability of being attacked within this case.

3) There is a restoration result. The table shown in FIG. 38 outlines the load restoration under each scenario across three cases, with the worst-case probability labeled accordingly. In Case 1, Scenario 10 dominates in the worst-case. Hence, the grid deployed the strategy to divide the main grid into two sub-grids to maximize load pick-up.

In Case 2, Scenarios 2, 3, 4, and 10 exhibit relatively equal probabilities, with each around 0.25. In response, the DRO model strategically divides the grid into three regions, ensuring optimal load restoration across these scenarios. It is noticed that compared to Case 1, this plan significantly enhances load pick-up in Scenario 2 particularly. For Case 3, Scenarios 1 and 2 take precedence. Here, the DRO model divides the main grid into three sub-grids, optimizing load restoration plans for Scenarios 1 and 2. This sub-grid strategy differs from Case 2, focusing on enhancing load restoration specifically in Scenarios 1 and 2.

Overall, when client nodes carry a higher probability of being targeted and potentially impacting more IBRs, the DRO model tends to segment the grid into more sub-grids, mitigating their impact within smaller areas. Nevertheless, this segmentation restricts the transfer of power within the grid, leading to lower load pick-up expectations in comparison to cases with fewer sub-grids.

There is a sensitivity analysis. The various graphs in FIG. 39 illustrate the sensitivity of the ambiguity set parameters (confidence level β, data size N, and the range of regional index [μ, μ̅]) in all cases. The default parameters are as follows: N=20k, β=95%, μ∈[0.3, 8]. In this analysis, only one parameter changes while others remain at their default values. The x-axis represents the attack scenario, while the y-axis indicates the probability in the worst cases. Each row signifies a specific case, whereas each column denotes the influence of a particular parameter across all cases.

It is noteworthy that an increase in N results in a contraction of the ambiguity set, leading to “improved” worst cases. This can be translated to a reduced probability of client nodes being attacked, potentially impacting fewer IBRs. It is observed that Cases 1 and 2 are more sensitive to this parameter. The dashed line indicates deviations in the sub-grid plan compared to the benchmark case. Case 3 exhibits robustness to changes in this parameter.

On the other hand, an increase in β leads to an extension of the ambiguity set, resulting in “worsened” worst cases. Cases 1 and 2 continue to display high sensitivity to β. Altering the confidence level may trigger changes in the sub-grid plan in these cases. Contrarily, Case 3 shows negligible sensitivity to this parameter.

When μ varies, notable sensitivity to this parameter is observed in Cases 2 and 3, particularly in Case 3. This is attributed to the impact of higher rational levels when client nodes are compromised, which compels attackers to target larger IBRs. However, this effect does not influence local controllers as their accessibility is confined to the local IBR. Consequently, Case 1 exhibits limited sensitivity to this parameter. On the contrary, when μ̅ fluctuates, Cases 1 and 2 show considerable sensitivity. The increase in μ̅ shifts the worst-case probability from local controllers to client nodes, resulting in “worsened” worst-case scenarios. In Case 3, where the most probable compromised nodes are assumed to be cluster leads, this scenario inherently represents the “worst” worst-case situation. Consequently, as μ̅ increases, there is limited scope for the already “worst” worst-case scenario to deteriorate further. This limitation results in minimal variations in the probability distribution within this case.

As noted above, the increasing integration of grid-edge DERs has brought several advantages to modern distribution grids. Positioned closer to the point of consumption, these resources effectively reduce energy losses typically incurred during long-distance transmission, thereby enhancing overall system efficiency. Moreover, by directly serving local loads and lowering the power demand on the transmission network, DERS augment the grid's operational capacity especially during peak hours, thus improving system reliability. Furthermore, the emerging grid-forming (GFM) DERs are capable of autonomously regulating voltage and frequency, ensuring grid stability and supporting local loads during transmission outages, significantly enhancing system resilience.

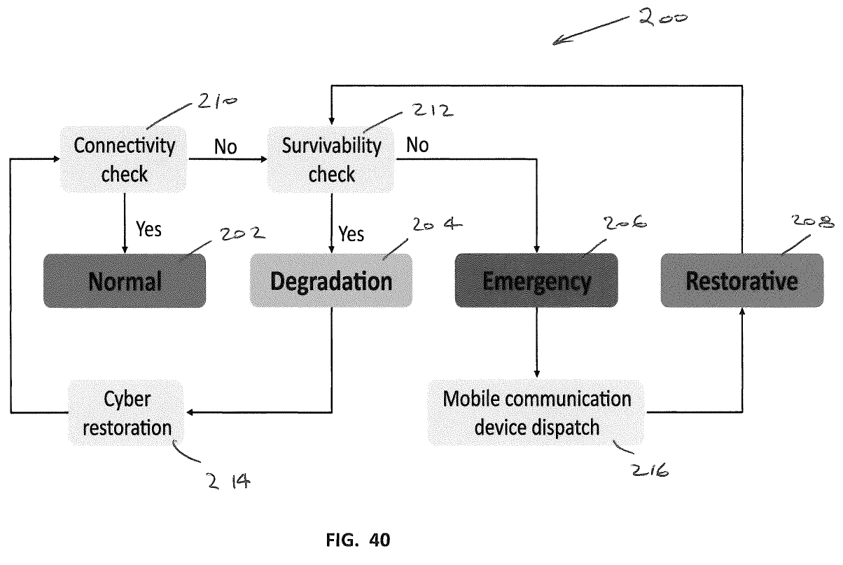

Given the rising potential for cyber threats to disrupt the cyber network, a secure operational guideline for DERs has been described above that emphasizes the importance of maintaining consistency between physical and cyber connectivity to ensure secure DER operation across all scenarios. When cyber network connectivity is compromised, such as during a cyberattack, the disruption of DER cyber connectivity can significantly impact the physical grid, potentially leading to load shedding. That framework has been extended by providing operational guidance for DERs under varying conditions of the cyber network to maximize load serving capacity across different network states and manage operational costs effectively. To achieve this, the grid shown schematically at 200 is categorized into four distinct states based on the condition of the cyber network: Normal 202, Degraded 204, Emergency 206, and Restorative 208, as illustrated by the blocks in FIG. 40. The negative connectivity check 210 moves to a survivability check 212. There is also a cyber restoration 214 and mobile communication dispatch 216.

In the normal state, the cyber layer operates at full capacity, with no or only minimal compromised components. Even in cases of minimal disruptions, network redundancy ensures complete connectivity among all DERs, allowing the system to effectively meet load demands. However, if cyber connectivity among DERs is severely compromised due to significant attacks, the system may transition into either a Degraded 204 or Emergency state 206, depending on the extent of the disruption.

In the Degradation state 204, the cyber connectivity of DERs is partially disrupted, leading the system to separate into several sub-grids to maintain both cyber and physical connectivity. This state is identified through a survivability check as described later. If the system passes this check, it indicates that the load can be fully or mostly served due to available DER capacity reserves, although the operating point may deviate from the Normal state, potentially resulting in increased grid losses. In scenarios where most of the load is served, any curtailed load can be shifted to non-peak hours, minimizing the impact on customers. Since no severe disruptions occur in this state, system operators can implement standard measures to gradually restore the cyber network and return the system to the Normal state.

If cyber connectivity continues to deteriorate, the formation of sub-grids may no longer be sufficient to prevent severe load shedding. This situation indicates that the system has failed its survivability check 212 and has entered the Emergency state 206. In this phase, to maximize load service, system parameters, such as line limits, are temporarily adjusted to emergency mode, typically set at 1.2 times the normal flow limit.

The entry into the Emergency state 206 can have significant social and economic repercussions for utility providers. To mitigate these impacts, mobile communication support devices, including emergency communication vehicles, are deployed to restore the core functionality of the cyber network 216. This transitional phase is known as the Restorative state 208. Once core functionalities are reinstated, the system may transition back to either the Degraded 204 or Normal state 202, depending on the extent of recovery achieved.

Therefore, based on the discussion above, a key to improving system performance under various cyber network conditions and mitigating the impacts of cyber threats lies in reducing the duration of the Emergency state 206. This means enhancing system survivability across all possible scenarios.

As described, system survivability refers to the system's ability to serve its load under a specific cyber condition, as discussed previously. It can be defined as the ratio of currently served load to the total load demand, making it a normalized quantity.

The state variables of the physical power system and the cyber network are taken into consideration, and the power consumed by the load and the load power demand. In the presence of potential cyber threats, the system adjusts both of its cyber and physical topologies to maximize load serving while ensuring the secure operation. This secure operation is constrained by a function of the state variables of the physical power system and cyber network. This includes both grid-related constraints and cyber-layer constraints, i.e., cyber and physical layer connectivity consistency constraints, as previously discussed. It can be inferred that enhancing system survivability requires maintaining the system's cyber capacity during attacks. This can be achieved through the following methods:

1) Enhance Security Measures: Implement advanced security controls, such as multi-layer firewalls, to filter out suspicious IP sources and protect critical components from unauthorized access, thereby lowering the risk of component compromise.

2) Improve Cyber System Redundancy: Design redundant cyber connections in the event of component failures. These alternative connections can help prevent service interruptions caused by cyber attacks.

3) Deploy Real-Time Detection Algorithms: This approach enables early detection and isolation of potential threats, minimizing their impact on the cyber network's capabilities.

4) Information Sharing: Collaborating with industry partners to share information, such as suspicious IP addresses, fosters a proactive approach that helps intercept potential threats before they can cause harm.

Among these methods, improving cyber redundancy is relatively easy to implement and causes minimal disruption to normal system operations. In contrast, while the other three methods are more robust, they require significantly more time for implementation, necessitating careful coordination and planning to manage potential outages during the upgrade process. Therefore, enhancing cyber redundancy can serve as an immediate measure to improve system survivability. The system uses the DRO framework that identifies the most effective redundancy strategy for the cyber layer, aiming to maximize system survivability within a given budget.

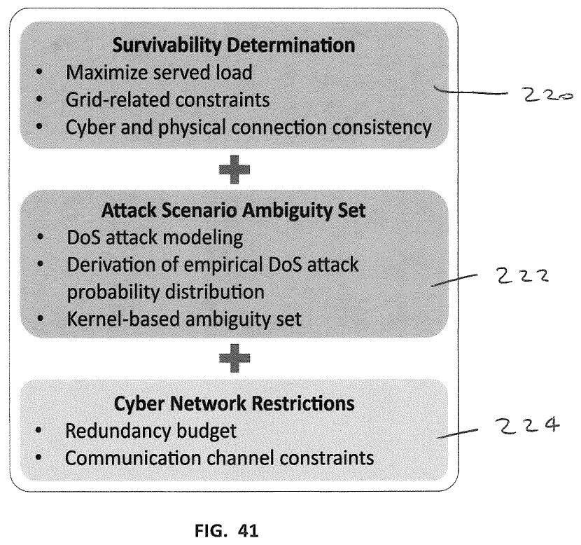

An overview of a DRO-based survivability enhancement model is shown in FIG. 41. This model has three modules. The first module is the survivability determination module 220, which is modeled as a conventional optimization problem to assess system survivability based on the status of the cyber layer (i.e., identifying compromised channels). This module takes into account both grid-related constraints and the consistency of cyber-physical connections.

The second module is the attack scenario ambiguity set establishment module 222. In real-world situations, DoS attacks can target various channels, making it challenging to predict the exact status of the cyber layer at any given moment. Therefore, an uncertainty model is more suitable than a deterministic one for modeling the attack scenarios. This module utilizes historical attack data to establish a set of probability distributions that reflect the likelihood of each scenario, ensuring that the actual distribution falls within this set with a high degree of confidence.

Compared to traditional stochastic optimization (SO) and robust optimization (RO) approaches, the DRO model offers distinct advantages. In SO, the empirical distribution is often used to approximate the true distribution. With limited historical data, however, this empirical distribution may significantly deviate from the actual distribution. By employing an ambiguity set that likely encompasses the true probability distribution, the DRO model enhances reliability. Additionally, while the RO model focuses solely on worst-case scenarios, often resulting in overly conservative results, the DRO model incorporates probability information from historical data, leading to more efficient and balanced results.

The third module is the cyber network constraints module 224. This module models the design constraints of the cyber network. On one hand, it ensures that the proposed redundancy plan remains within budge. On the other hand, it guarantees that the upgraded network topology complies with the necessary communication standards, ensuring reliable performance. Once all modules are developed, the DRO model can be established, allowing for the derivation of the optimal channel redundancy plan. This plan aims to ensure maximum survivability across all potential attack scenarios.

As described above, a DoS attack is executed by flooding the server buffer with junk packets, causing legitimate incoming packets to be discarded and disrupting the communication channel connectivity. These attacks can originate from a single source or multiple sources, the latter also being referred to as Distributed Denial of Service (DDoS) attacks. DDoS attacks require significantly more resources and highly efficient coordination, making them less common than single-source attacks, and thus, emphasis is primarily focused on single-source attacks in this description.

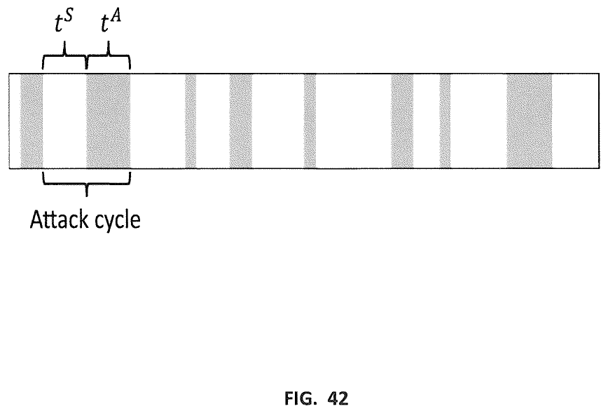

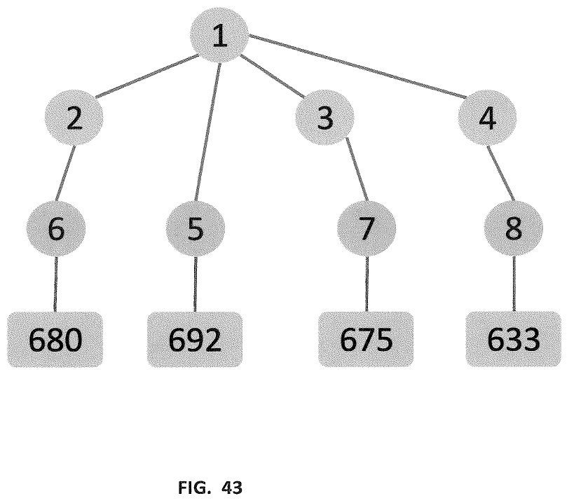

A typical single-source DoS attack can last from minutes to hours, during which the attackers aims to disrupt the availability of a specific channel. However, due to limited energy resources, continuous disruption is not feasible. As a result, the duration of DoS attacks generally follows an intermittent pattern, as shown in the time phase diagram of FIG. 42. This duration can be broken down into a series of attack cycles. Each cycle begins with a charging phase, during which attackers use energy harvesters to recharge their batteries. In this phase, referred to as “sleep” time (tS), no attacks occur. Once charging is complete, attackers enter the attack phase, denoted as tA in FIG. 42, which continues until the energy is depleted. At this point, the batteries recharge, initiating a new attack cycle. The durations of tS (sleep time) and tA (attack time) can vary significantly based on network conditions, available resources, and environmental factors, making them difficult to predict. Since each attack cycle is independent, the attack cycles recorded by network traffic monitoring tools can be used to estimate the likelihood of each channel being in either the “sleep” or “attack” phase during the attack duration. This approach allows for the development of an empirical probability distribution that reflects the likelihood of different attack scenarios.

A cyber network architecture is explained above. The communication links can exist between DER clients or between clients and local controllers. Since the links between client nodes are more critical and can impact more DERs, attackers are more likely to target them. Thus, the DoS attack scenarios at any given moment can be modeled as a discrete set based on an attack target channel and an attack status.

Given the limited availability of data, the empirical distribution from historical data may not reliably reflect the true probability of attacks. A more effective strategy is to use an ambiguity set centered around the empirical distribution. This approach is designed to ensure, with high confidence, that the true probability lies within the set, effectively capturing the uncertainty inherent in various attack scenarios.

When the true distribution shape and statistical information are unknown, both discrepancy-based and kernel-based ambiguity sets can effectively model uncertainty. Among the various discrepancy-based approaches, the Wasserstein ball-based ambiguity set is noted for its strong out-of-sample performance. Conversely, kernel-based ambiguity sets have shown superior convergence properties, a kernel-based ambiguity set is used to model the uncertainty associated with attack scenarios and comparisons of different methods are explained in simulation results.

Unlike other methods that rely on probability distribution functions, a kernel-based approach uses a Kernel Mean Embedding (KME) to represent an empirical distribution. A Gaussian kernel may be employed due to its superior performance across a wide range of datasets. A probability level may be determined for each attack scenario in a reproducing kernel Hilbert space generated by a Gaussian kernel. An ambiguity set is defined using a Maximum Mean Discrepancy (MMD) that includes all distributions for which the MMD between any distribution in the set and the empirical distributor is less than a specified constant.

To enhance system survivability, an effective solution is to introduce redundancy into the cyber system, as previously discussed. It is possible to add alternative communication channels within the existing cyber network. Once pre-configured, these channels can establish connections within milliseconds, effectively restoring network connectivity disrupted by DoS attacks.

There are operational constraints and cyber network restrictions. To ensure the feasibility of this model, it is necessary to consider communication network design guidelines, otherwise, network performance could be severely impacted. One key guideline addressed in this work is the limitation on the number of links established by each client-server pair. Excessive channel establishment can significantly reduce a server's processing rate. Consequently, there is typically an upper limit on the number of channels connected to each server.

Additionally, to manage implementation costs, the redundancy budget must also be taken into account. This is modeled by regulating the number of added channels.

After a reformulation process, the DRO problem becomes a tri-level tractable problem. Generally, such problems can be solved using either the dual method or the cutting plane method. However, due to the presence of binary variables in the inner problem, a dual function takes a quadratic form, making it unsuitable for solving this problem. Instead, the cutting plane-based C&CG algorithm is more appropriate, given its excellent convergence properties.

The core idea behind the C&CG algorithm is to decompose a multi-level optimization problem into a master problem and a subproblem, each of which can be solved independently and provide either lower or upper bounds on the objective value. The optimal solutions from the master and subproblems are iteratively derived and exchanged, facilitating to a gradual convergence of the upper and lower bounds, ultimately leading to the final solution.

A simulation involved an IEEE 13-node test feeder that had been modified to integrate DERs at Nodes 680, 675, 633, and 692, with capacities of 1,000 kW, 1,000 kW, 1,200 kW, and 600 KW, respectively. To enable the grid reconfiguration, circuit breakers were installed at Lines 670671, 671692, 692675, and 632633. The associated cyber-physical network is illustrated in FIG. 43, where Nodes 1, 2, 3, and 4 operate as clients, while Nodes 5, 6, 7, and 8 function as local controllers, each responsible for managing a corresponding DER shown with the four numbers: 680, 692, 675, and 633. Initially, the cyber network is designed to facilitate the interconnection of DERs with one another.

In the event of DoS attacks targeting the communication links between client nodes, connections among DERS may be compromised, leading the grid to reconfigure into several sub-grids. This sectionalization helps maintain the integrity of both cyber and physical connectivity among all DERs, although it may result in load shedding. To enhance system survivability, a redundancy plan is implemented with a budget for one additional communication link, aimed at improving DER connectivity during attacks.

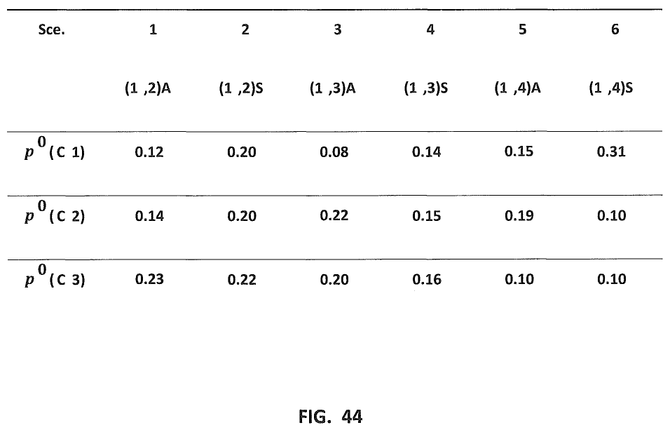

Three distinct cases have been analyzed, each characterized by different empirical distributions of DoS attacks, as shown in the table of FIG. 44. This table also presents the possible attack scenarios, with a total of six scenarios. Each compromised link includes two scenarios: “A” indicates the attack status, while “S” represents the sleep status. The attack scenario with the highest probability of each case is shown in the table of FIG. 44.

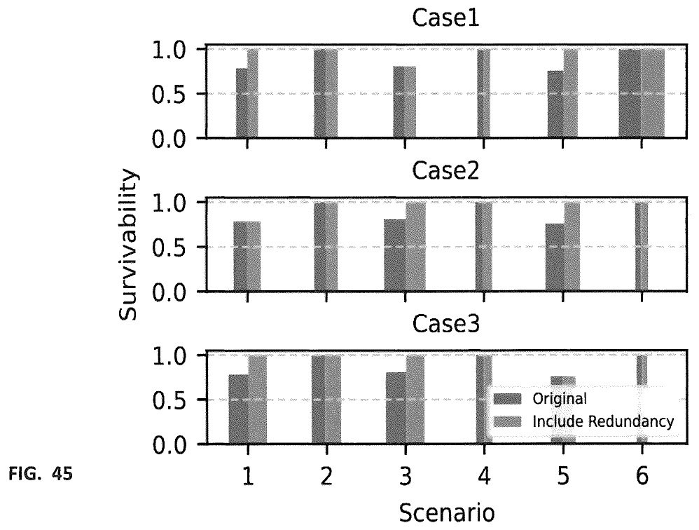

The bar charts shown in FIG. 45 illustrate the system's survivability across three cases. The width of each bar represents the worst-case probability of the corresponding scenario, while the height indicates the system's survivability under that scenario. The first bars in each set of two bars reflect the original survivability of the system, whereas the second bars represent the survivability achieved by implementing the redundancy plan. Due to compromised links in Scenarios 1, 3, and 5 shown in FIG. 45, the system in its original condition cannot serve the full load, resulting in survivability below 1 and placing the system in the Emergency state. In Case 1, Link (1, 4) is identified as the most likely target for an attack, prompting the algorithm to prioritize Scenario 5. The proposed redundancy plan introduces an additional Link (2, 4), enabling Node 4 to maintain a complete DER cyber connection through Link (2,4) if Link (1,4) is compromised. Additionally, if Link (1,2) is compromised, Link (2, 4) also preserves the DER connection. Consequently, in Scenarios 1 and 5, the system can serve all loads, restoring survivability to 1 and returning the system to Normal state. In Scenario 3, however, when Link (1, 3) is compromised, the additional link does not recover the lost connection, leaving system survivability unchanged. Nonetheless, because survivability in Scenario 3 is relatively higher, the algorithm deprioritizes this scenario.

Similarly, in Cases 2 and 3, variations in the attack probability distribution led the algorithm to prioritize different attack scenarios and recommend distinct redundancy plans. In Case 2, the additional link identified is (3,4), while in Case 3, it is (2, 3). The simulation results illustrate that the empirical distribution can significantly influence the chosen redundancy plan. Therefore, if the empirical distribution changes substantially, it may be necessary to reassess the redundancy plan to ensure optimal system performance.

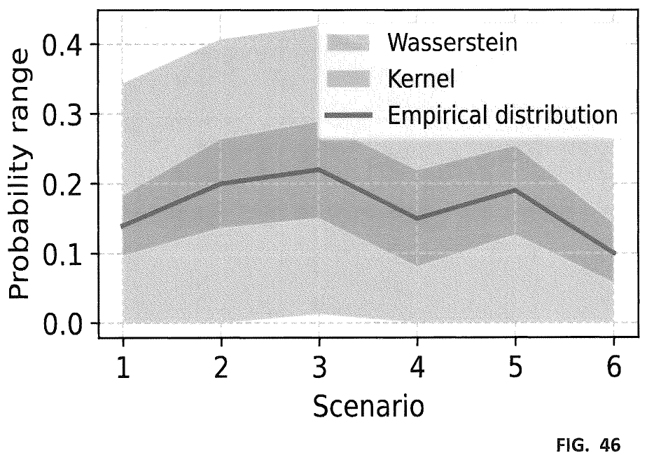

It is possible to compare kernel-based and Wasserstein ball-based ambiguity sets. While the Wasserstein ball-based set is the most widely used discrepancy-based ambiguity set for shape-unknown probability distributions, it encompasses a much larger distribution space than the kernel-based set. Taking Case 2 as an example, the graph in FIG. 46 illustrates the probability range for each attack scenario at the same confidence level for both sets. The kernel-based ambiguity set exhibits a significantly narrower probability range, roughly one-third that of the Wasserstein ball-based set of each scenario. As a result, the worst-case probability distribution derived from the kernel-based set is much closer to the actual distribution. Given that the DRO algorithm focuses on improving the worst-case scenario, the solution derived from the kernel-based ambiguity set is therefore more accurate and effective.

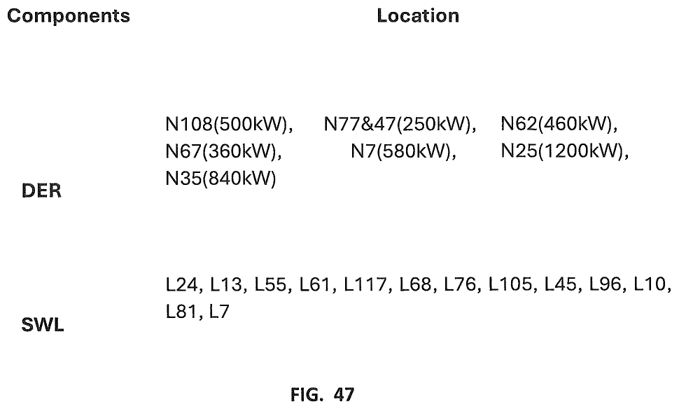

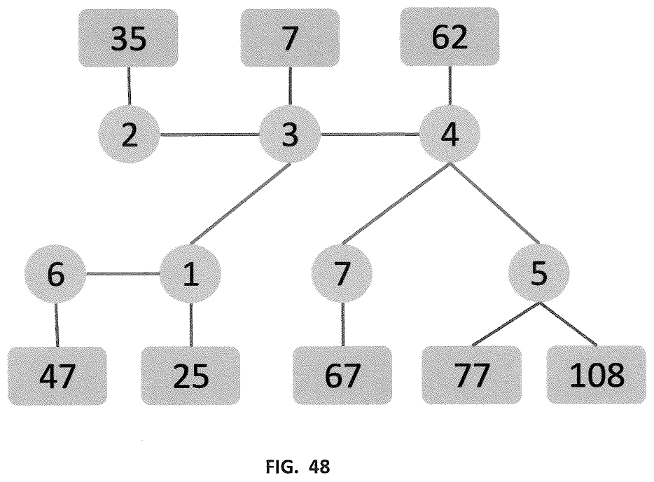

Another test system was an IEEE 123-node test feeder has been modified to incorporate 8 DERs at the grid edge and 13 switchable lines (SWLs) for a system reconfiguration. Their locations are detailed in the table shown in FIG. 47. The corresponding cyber network topology is illustrated in FIG. 48. In this figure, the circular nodes represent client nodes, while the numbered rectangular blocks indicate DER units, consistent with the setup in IEEE 13 node test cases. For simplicity, the local controllers associated with each DER, which interface with the corresponding client nodes, have been omitted from the figure.

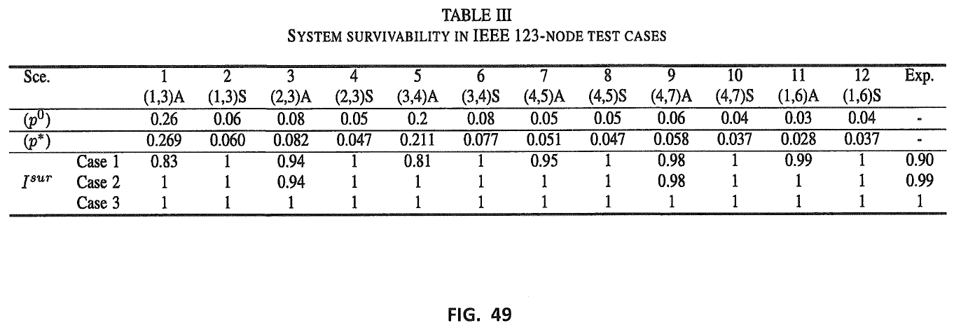

The system survivability results for the IEEE 123-node test cases are presented in the table shown in FIG. 49. In this table, po represents the empirical probability derived from historical data, while p* corresponds to the worst-case probability distribution. The survivability analysis considers three cases. Case 1 represents the original system with no additional cyber links. In Case 2, a redundancy plan with a budget of 1 is introduced. In Case 3, the budget is increased to 2.

In Case 1, all attack scenarios, which correspond to the odd-numbered scenarios, result in a reduction of system survivability, leading to load shedding within the grid. Scenarios 1 and 5 are particularly severe, causing approximately one-fifth of the system's load to be shed. To ensure robust performance under these worst-case conditions, these two scenarios are prioritized by pushing their probabilities toward the upper limit of the ambiguity set in the worst-case distribution. Consequently, their probabilities are higher in the worst-case scenario than those indicated by the empirical data.

In Case 2, the redundancy plan enables the introduction of a single additional link, specifically designed to enhance survivability in Scenarios 1 and 5. The algorithm identifies link (5, 6) as the optimal choice. This additional link ensures full connectivity of DERs in the cyber layer for both Scenarios 1 and 5, effectively restoring system survivability to 1. Moreover, this link also helps maintain connectivity in Scenarios 7 and 11. Although the system continues to experience load shedding in Scenarios 3 and 9, their low probabilities allow the overall expectation of system survivability to recover to 0.99.

In Case 3, with the addition of two links, the algorithm recommends introducing another link (2,7), in addition to the previously proposed link (5, 6). This enhancement further improves system connectivity, particularly in Scenarios 3 and 9, ensuring full connectivity across all scenarios. As a result, system survivability remains at 1 throughout all scenarios.

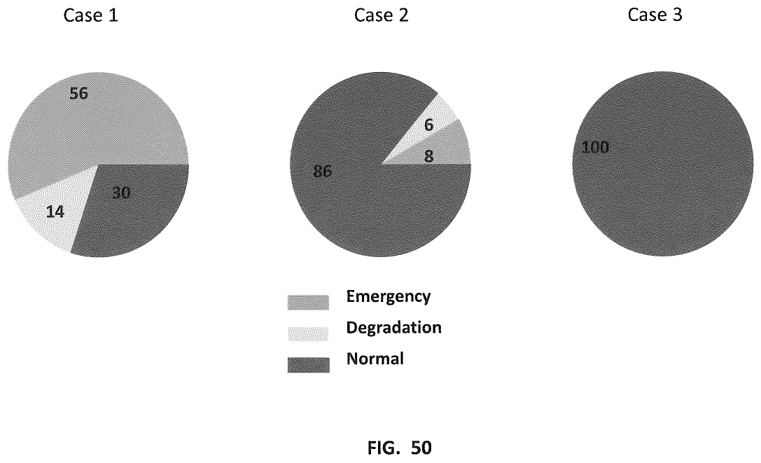

The pie charts in FIG. 50 display the system state percentages across the three cases under the worst-case probability distribution. In Case 1, it is observed that there is only a 30% chance of the system operating in the Normal state, while over half of the probability points to operation in the Emergency state. This highlights the urgent need for actions to improve system survivability, despite the survivability expectation of 0.9 indicated in the table of FIG. 49.

In Case 2, while the expected survivability is nearly perfect at 0.99, the pie chart indicates that the system still has a 6% chance of operating in a Degradation state and an 8% chance in an Emergency state. This discrepancy arises because survivability is measured quantitatively. Therefore, the system may still exhibit a relatively high level of survivability, even in the Emergency state, contributing to the overall high survivability rating. However, as the term “Emergency” implies, this state requires immediate attention to mitigate potential severe impacts on customers. Consequently, for more risk averse stakeholders, Case 2 may not satisfy strict reliability standards and could necessitate further improvements.

In Case 3, with all connections secured across all scenarios, the system is guaranteed to operate in Normal state 100% of the time.

In practice, alongside using the DRO-based technique to identify optimal survivability improvement plans, operators may also incorporate operation state probability analysis to determine the most suitable budget for these plans. This approach ensures that the system minimizes the risk of largescale load shedding, effectively meeting all reliability and security requirements.

The choices for β and N can be referred to above in our previous work [11]. A higher β results in a larger ambiguity set, leading to more conservative outcomes. Conversely, a larger N reduces the size of the ambiguity set, yielding more reliable results. However, outdated data may not accurately reflect current attack source capacities, making it unsuitable for predicting the actual attack probability distribution. Therefore, it is recommended that the data used should be no older than two years.

The parameter σ controls the smoothness of the distribution constructed from the dataset. A larger σ can lead to over smoothing, resulting in the loss of important distributional information, while a smaller σ may make the distribution overly sensitive to noise, compromising its robustness. A good starting point for selecting σ can be based on Silverman's rule of thumb, which provides a practical method for determining σ based on certain properties of the data set. In our case, σ is estimated to be 0.1.

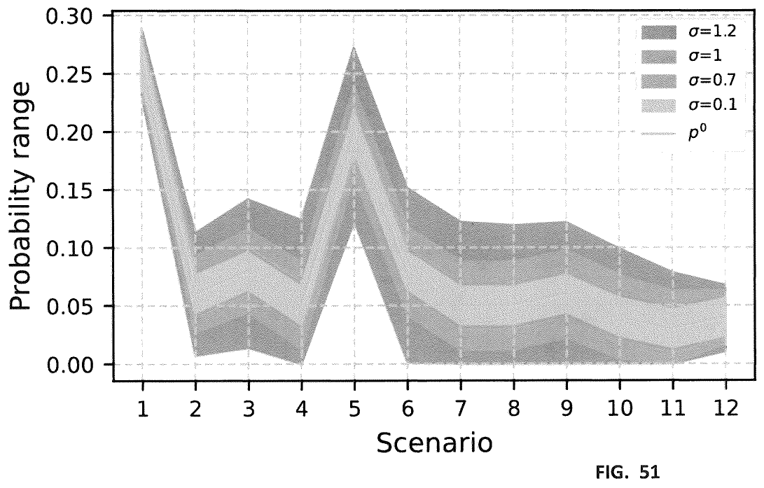

The graph in FIG. 51 illustrates the probability range of the ambiguity set in the IEEE 123-node test case under different values of σ. When σ=0.1, the ambiguity set forms a narrow band that closely aligns with the empirical data. As σ increases, the ambiguity set gradually expands, although only slight extensions are observed up to σ=0.7. Within this range, the minimal variation in the ambiguity set indicates that the choice of σ does not significantly impact the performance of the proposed algorithm.

As σ continues to increase, the ambiguity set grows substantially, particularly at σ=1, where significant changes in its shape are observed. At σ=1.2, even a relatively small increase leads to a noticeable expansion of the ambiguity set, resulting in an overly smooth shape that deviates from the empirical distribution. This smoothness causes a loss of critical probability information from the historical data, potentially yielding a worst-case distribution that significantly diverges from reality, thereby reducing the effectiveness of the derived solution.

In summary, an appropriate range for σ would be between 0.1 and 0.7.

It is evident that a distributionally robust optimization model may enhance system survivability against DoS attacks by improving redundancy within cyber networks. Initially, the concept of system survivability is redefined to incorporate the specific conditions of the cyber layer. A kernel-based ambiguity set encapsulates the uncertainties associated with various attack scenarios. The DRO model is formulated to optimize redundancy planning. To facilitate efficient solutions, this tri-level optimization problem is then reformulated using the C&CG algorithm.

The simulation results demonstrate the model's effectiveness in enhancing system survivability. It empowers operators to bolster the resilience of existing systems against DoS attacks. Furthermore, by incorporating cyber-physical interdependencies and aligning operational guidelines across both layers, this model is applicable to a wide range of cybersecurity analysis scenarios. One notable application is the development of redundancy plans tailored to different attack scenarios. By accurately modeling the impact of these attacks on the cyber layer, the model can be adapted to address various threat situations effectively.

By quantifying the impact of specific defensive measures on the cyber layer, such as decreasing attack probabilities through firewalls or refining the probability range of attacks with detection algorithms, this model serves as an effective tool for developing optimal defensive strategies.

The algorithm is a valuable tool for coordinating cyber enhancement efforts aimed at improving system performance in the physical layer, ultimately strengthening the overall resilience of the cyber-physical power system.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A system for restoring an electrical distribution grid from cyber-physical attacks, comprising:
a plurality of local controllers, each having a grid-edge, inverter-based resource (IBR) field device connected thereto, said local controllers arranged in a plurality of IBR local controller clusters and configured to collect IBR field device measurement data from respective IBR field devices and compute power ratio deviations and regulate terminal voltages and system frequency of respective IBR field devices;
a plurality of IBR manager clients, each configured to communicate with one or more IBR local controller clusters and one or more neighboring IBR manager clients and receive IBR field device measurement data and power ratio deviations for each IBR field device in communication therewith and direct a respective local controller to adjust terminal voltage and system frequency within a connected IBR field device; and
a management server system connected to the plurality of IBR manager clients, said management server system configured to implement a distributionally robust optimization (DRO) model and generate a sub-grid plan of terminal voltages and system frequencies for the IBR manager clients and local controllers that minimizes expected load loss and compensates for power ratio deviations when the electrical distribution grid is subject to a cyber-physical attack.

2. The system of claim 1 wherein said DRO model integrates an ambiguity set to address a cyber-physical attack scenario uncertainty.

3. The system of claim 2 wherein said ambiguity set comprises a Wasserstein ball-based distribution set that presents a possibility level of each attack scenario.

4. The system of claim 1 wherein said management server system is configured to generate the sub-grid plan using spatial-temporal correlations among voltage phasors at nodal buses defined by IBR field devices.

5. The system of claim 4 wherein said management server system is configured to compute unknown voltages from the spatial-temporal correlations.

6. The system of claim 4 wherein said sub-grid plan includes isolation of IBR field devices and local controllers within the electrical distribution grid.

7. The system of claim 1 wherein each IBR field device comprises an electric field sensor.

8. A system for restoring an electrical distribution grid from cyber-physical attacks, comprising:
a plurality of inverter-based resource (IBR) manager clients, each configured to communicate with each other and receive IBR field device measurement data and power ratio deviations from IBR field devices; and
a management server system connected to the plurality of IBR manager clients, said management server system configured to implement a distributionally robust optimization (DRO) model based upon received IBR field device management data and power ratio deviations and generate a sub-grid plan of terminal voltages and system frequencies for IBR field devices to minimize expected load loss and compensate for power ratio deviations when the electrical distribution grid is subject to a cyber-physical attack.

9. The system of claim 8 wherein said DRO model integrates an ambiguity set to address a cyber-physical attack scenario uncertainty.

10. The system of claim 9 wherein said ambiguity set comprises a Wasserstein ball-based distribution set that presents a possibility level of each attack scenario.

11. The system of claim 8 wherein said management server system is configured to generate the sub-grid plan using spatial-temporal correlations among voltage phasors at nodal buses within the electrical distribution grid.

12. The system of claim 11 wherein said management server system is configured to compute unknown voltages from the spatial-temporal correlations.

13. The system of claim 11 wherein said sub-grid plan includes isolation of IBR field devices within the electrical distribution grid.

14. The system of claim 8 wherein each of said IBR field devices comprise an electric field sensor.

15. A method for restoring an electrical distribution grid from cyber-physical attacks, comprising:
receiving inverter-based resource (IBR) field device measurement data and power ratio deviations within a plurality of inverter-based resource (IBR) manager clients;
determining a distributionally robust optimization (DRO) model within a management server system using received IBR field device management data and power ratio deviations from IBR manager clients; and
generating a sub-grid plan of terminal voltages and system frequencies for IBR field devices to minimize expected load loss and compensate for power ratio deviations when the electrical distribution grid is subject to a cyber-physical attack.

16. The method of claim 15 wherein said DRO model integrates an ambiguity set to address a cyber-physical attack scenario uncertainty.

17. The method of claim 16 wherein said ambiguity set comprises a Wasserstein ball-based distribution set that presents a possibility level of each attack scenario.

18. The method of claim 15 wherein said management server system is configured to generate the sub-grid plan using spatial-temporal correlations among voltage phasors at nodal buses within the electrical distribution grid.

19. The method of claim 18 wherein said management server system is configured to compute unknown voltages from the spatial-temporal correlations.

20. The system of claim 18 wherein said sub-grid plan includes isolation of IBR field devices within the electrical distribution grid.
